(19) United States
(12) Patent Application Publication
(10) Pub. No.: US 2025/0257702 A1
(43) Pub. Date: Aug. 14, 2025

(54) ROTATING DETONATION ENGINE WITH SECONDARY COMBUSTION AND COMBINED CYCLE PROPULSION

(71) Applicant: Venus Aerospace Corp., Houston, TX (US)

(72) Inventors: Andrew Thomas DUGGLEBY, Friendswood, TX (US); Vishal DOSHI, Costa Mesa, CA (US); Ali MORADI, Boulder, CO (US); Hannah McCALLUM, Redondo Beach, CA (US); Aaron Ezekiel SMITH, Hermosa Beach, CA (US)

(73) Assignee: Venus Aerospace Corp., Houston, TX (US)

(21) Appl. No.: 18/620,981

(22) Filed: Mar. 28, 2024

Related U.S. Application Data
(63) Continuation-in-part of application No. 18/484,989, filed on Oct. 11, 2023, now abandoned.
Application No. 18/484,989 is a continuation of application No. 18/178,456, filed on Mar. 3, 2023, now Pat. No. 11,840,988.

(51) Int. Cl. F02K 9/64; F02K 9/96; F23R 7/00

(52) U.S. Cl. CPC F02K 9/64; F02K 9/96; F23R 7/00

(57) ABSTRACT

A rotating detonation rocket engine system including a fuel source containing a fuel. A liquid peroxide source providing liquid peroxide within a rotating detonation engine such that a first surface of a wall partially defining the combustion chamber of the rotating detonation engine is cooled. A monitor configured to control a flow of the fuel and a flow of the liquid peroxide. The monitor is configured to ensure that a stoichiometry of a combination of the fuel and the liquid peroxide is appropriate for generating a combustion of the combination of the fuel and the liquid peroxide.

### CROSS-REFERENCE TO RELATED APPLICATIONS

This application is a Continuation-in-Part and claims priority to and benefit of co-pending U.S. patent application Ser. No. 18/484,989, filed on Oct. 11, 2023, entitled “FILM COOLING WITH ROTATING DETONATION ENGINE TO SECONDARY COMBUSTION” by Aaron Ezekiel Smith, and assigned to the assignee of the present application, the disclosure of which is incorporated herein by reference in its entirety.

U.S. patent application Ser. No. 18/484,989 is a Continuation of and claims priority to and benefit of co-pending U.S. patent application Ser. No. 18/178,456, filed on Mar. 3, 2023, entitled “FILM COOLING WITH ROTATING DETONATION ENGINE TO SECONDARY COMBUSTION” by Aaron Ezekiel Smith, and assigned to the assignee of the present application, the disclosure of which is incorporated herein by reference in its entirety.

### BACKGROUND

The embodiments of the present invention relate generally to rockets, rocket engines with secondary combustion, and combined cycle propulsion systems.

### SUMMARY

Various embodiments of the present invention relate to rocket engine systems with improved cooling.

In one embodiment, a rocket engine and cooling system include a coolant source for providing a coolant, a propellant source, a pressurization system, and a heat exchanger. In some embodiments, one or more of the coolant source and the propellant source is in operative communication with the pressurization system and the rocket engine such that the coolant can be pressurized and then heated by a heat exchanger. In various embodiments, the coolant is heated to a temperature and pressure such that the coolant is at a supercritical state. In various embodiments, the coolant is heated to a temperature and pressure which is below the temperature or pressure at which the coolant reaches a supercritical state. In various embodiments, the coolant is heated to a temperature and pressure which is above the temperature or pressure at which the coolant reaches a supercritical state.

In one embodiment, the propellant source includes one or more of a fuel, an oxidizer, and a coolant. In various embodiments, the oxidizer may be pre-mixed with the fuel, and the coolant.

In various embodiments, the coolant may be a fuel, an oxidizer, or an inert coolant.

In various other embodiments, the rocket engine and cooling system includes a cooling system with a coolant source for providing coolant, a fuel system with a fuel source for providing fuel, an oxidizer system with an oxidizer source for providing an oxidizer, a propellant pressurizing system with a pressurization source for pressurizing the propellant, and a heat exchanger. In various embodiments, the pressurization source communicates with the coolant after the coolant passes through the rocket engine and the heat exchanger. One such embodiment is referred to herein as an expander cycle.

In some embodiments, the improved rocket engine system includes a cooling system with a coolant source for providing coolant, a fuel system with a fuel source for providing fuel, an oxidizer system with an oxidizer source for providing an oxidizer, a propellant pressurizing system with a pressurization source for pressurizing the propellant, and a heat exchanger. In some embodiments, the pressurization source communicates with the coolant after the coolant passes through the rocket engine and the heat exchanger (e. g., an expander cycle), and an aerospike nozzle which is cooled by the coolant after the coolant has powered the pressurization system.

Some embodiments of the present invention include a cooling system with a coolant source for providing coolant, a fuel system with a fuel source for providing fuel, an oxidizer system with an oxidizer source for providing an oxidizer, a propellant pressurizing system with a propellant pressurizing source for pressuring the propellant, and a preburner. In one such embodiment, the pressurization source is driven by the coolant after the coolant passes through the rocket engine and heat exchanger (e. g., an expander cycle). The preburner is used to achieve a side combustion reaction between the fuel and the oxidizer wherein the coolant is heated to a temperature and pressure such that the coolant is at a supercritical state. In various embodiments, the preburner is used to achieve a side combustion reaction between the fuel and the oxidizer wherein the coolant is heated to a temperature and pressure which is below the temperature or pressure at which the coolant reaches a supercritical state. In various embodiments, the preburner is used to achieve a side combustion reaction between the fuel and the oxidizer wherein the coolant is heated to a temperature and pressure which is above the temperature or pressure at which the coolant reaches a supercritical state.

Some embodiments of the present invention include a cooling system utilizing a coolant fuel to provide film cooling and wherein the coolant fuel is subsequently used to generate a secondary combustion. In one such embodiment, an oxidizer is combined with the coolant fuel after the coolant fuel has been used for film cooling. In various embodiments, the amount of coolant fuel and the amount of oxidizer are controlled to ensure that the stoichiometry between the coolant fuel and oxidizer is appropriate for the secondary combustion.

### BRIEF DESCRIPTION OF THE DRAWINGS

These and other characteristics of the present invention will be more fully understood by reference to the following detailed description in conjunction with the attached drawings, in which:

FIG. 1 is a detailed schematic view of an embodiment of an improved rocket engine system wherein the coolant is heated to a temperature and pressure such that the coolant is at a supercritical state, or the coolant is heated to a temperature or pressure which is below the temperature or pressure at which the coolant reaches a supercritical state, or the coolant is heated to a temperature and pressure which is above the temperature or pressure at which the coolant reaches a supercritical state according to embodiments of the present invention, and FIG. 1 schematically depicts a coolant source, a fuel source, an oxidizer source, a pressurization system, a heat exchanger, and rocket engine, in accordance with embodiments of the present invention.

FIG. 2 is a detailed schematic view of an embodiment of an improved rocket engine system wherein the coolant is heated to a temperature and pressure such that the coolant is at a supercritical state, or the coolant is heated to a temperature and pressure which is below the temperature or pressure at which the coolant reaches a supercritical state, or the coolant is heated to a temperature and pressure which is above the temperature or pressure at which the coolant reaches a supercritical state according to embodiments of the present invention, and FIG. 2 schematically depicts a coolant source, a fuel source, an oxidizer source, a pressurization system, a heat exchanger, and rocket engine with an aerospike nozzle, in accordance with embodiments of the present invention.

FIG. 3 is a detailed schematic view of an embodiment of an improved rocket engine system wherein the coolant is heated to a temperature and pressure such that the coolant is at a supercritical state, or the coolant is heated to a temperature and pressure which is below the temperature or pressure at which the coolant reaches a supercritical state, or the coolant is heated to a temperature and pressure which is above the temperature or pressure at which the coolant reaches a supercritical state according to embodiments of the present invention, and FIG. 3 schematically depicts a coolant source, a fuel source, an oxidizer source, a pressurization system, a preburner, and a rocket engine with an aerospike nozzle, in accordance with embodiments of the present invention.

FIG. 4 is a detailed schematic view of an embodiment of an improved rocket engine system wherein the coolant is heated to a temperature and pressure such that the coolant is at a supercritical state, or the coolant is heated to a temperature and pressure which is below the temperature or pressure at which the coolant reaches a supercritical state, or the coolant is heated to a temperature and pressure which is above the temperature or pressure at which the coolant reaches a supercritical state according to embodiments of the present invention, and FIG. 4 schematically depicts a coolant source, a fuel source, an oxidizer source, a pressurization system, a preburner in an alternate configuration, and rocket engine with an aerospike nozzle, in accordance with embodiments of the present invention.

FIG. 5 is a schematic cut-away view of an embodiment of an improved rocket engine system wherein the coolant is applied to the rocket engine to achieve film cooling of the rocket engine, in accordance with embodiments of the present invention.

FIG. 6 is a perspective view of a continuous injection port and a slot injection port used to apply coolant to achieve film cooling of a rocket engine, in accordance with embodiments of the present invention.

FIG. 7 is a schematic cut-away view of a rotating detonation engine, in accordance with embodiments of the present invention.

FIG. 8 is a cut-away view of walls defining an annulus wherein detonation occurs in a rotating detonation engine and wherein one wall is treated, in accordance with embodiments of the present invention.

FIG. 9 is a cut-away view of walls defining an annulus wherein detonation occurs in a rotating detonation engine and wherein two walls are treated, in accordance with embodiments of the present invention.

FIG. 10 is a schematic diagram of components of an improved rocket engine system wherein the fuel is combined with an oxidizer to obtain a secondary combustion, in accordance with embodiments of the present invention.

FIG. 11 is a cut-away view of a wall defining a chamber wherein combustion occurs in a rocket engine and wherein the wall is treated, in accordance with embodiments of the present invention.

FIG. 12 is a cross-sectional view of a series of nested rotating detonation rocket engine (RDRE) annuli with offset exhaust openings, in accordance with embodiments of the present invention.

FIG. 13 is a cross-sectional view of a series of nested rotating detonation rocket engine (RDRE) annuli with non-parallel exhaust regions, in accordance with embodiments of the present invention.

FIG. 14 is a cross-sectional view of a series of nested rotating detonation rocket engine (RDRE) annuli having parallel exhaust regions and non-offset exhaust openings, in accordance with embodiments of the present invention.

FIG. 15 is a cross-sectional view of a non-circular annulus of a rotating detonation rocket engine (RDRE), in accordance with embodiments of the present invention.

FIG. 16 is a cross-sectional view of a non-circular annulus of a rotating detonation rocket engine (RDRE) wherein fuel is selectively deliverable to portions of the non-circular annulus, in accordance with embodiments of the present invention.

FIG. 17 is a cut-away top view of a combined cycle combustion system having a rotating detonation rocket engine (RDRE) in combination with a second propulsion system and wherein the thrust vector for the RDRE is not parallel with the thrust vector for the second propulsion system, in accordance with embodiments of the present invention.

FIG. 18 is a cut-away side view of the combined cycle combustion system of FIG. 17, having a rotating detonation rocket engine (RDRE) in combination with a second propulsion system and wherein the thrust vector for the RDRE is not parallel with the thrust vector for the second propulsion system, in accordance with embodiments of the present invention.

FIG. 19 is a cut-away side view of a combined cycle combustion system having a rotating detonation rocket engine (RDRE) in combination with a second propulsion system and wherein the thrust vector for the RDRE is parallel with the thrust vector for the second propulsion system, in accordance with embodiments of the present invention.

FIG. 20 is a cut-away side view of walls defining an annulus of an RDRE wherein the inner wall has a tapered profile, in accordance with embodiments of the present invention.

FIG. 21 is a cut-away side view of walls defining an annulus of an RDRE wherein the outer wall has a tapered profile, in accordance with embodiments of the present invention.

FIG. 22 is a cut-away side view of walls defining an annulus of an RDRE wherein both the inner wall and the outer wall have a tapered profile, in accordance with embodiments of the present invention.

FIG. 23A is a cut-away front view of walls defining an annulus of an RDRE wherein the inner wall has crenellations extending therefrom, in accordance with embodiments of the present invention.

FIG. 23B is a side view of the annulus of an RDRE of FIG. 23A, and depicts a reduced mixing length, in accordance with embodiments of the present invention.

FIG. 24 is a cut-away side view of walls defining an annulus of an RDRE wherein both the inner wall and the outer wall have ceramic cylinders extending therefrom, in accordance with embodiments of the present invention.

FIG. 25 is a cut-away side view of walls defining an annulus of an RDRE wherein both the inner wall and the outer wall have piercings formed therein, in accordance with embodiments of the present invention.

The drawings referred to in this brief description of the drawings should not be understood as being drawn to scale unless specifically noted.

### DETAILED DESCRIPTION OF EMBODIMENTS

Reference will now be made in detail to various embodiments of the subject matter, examples of which are illustrated in the accompanying drawings. While various embodiments are discussed herein, it will be understood that they are not intended to limit to these embodiments. On the contrary, the presented embodiments are intended to cover alternatives, modifications, and equivalents, which may be included in the spirit and scope of the various embodiments. Furthermore, in this Description of Embodiments, numerous specific details are set forth in order to provide a thorough understanding of embodiments of the present subject matter. However, embodiments may be practiced without these specific details. In other instances, well known methods, procedures, components, and circuits have not been described in detail so as not to unnecessarily obscure aspects of the described embodiments.

Reference throughout this specification to “one embodiment,” “certain embodiments,” “an embodiment,” “various embodiments,” “some embodiments,” or similar term(s) means that a particular feature, structure, or characteristic described in connection with the embodiment is included in at least one embodiment. Thus, the appearances of such phrases in various places throughout this specification are not necessarily all referring to the same embodiment. Furthermore, the particular features, structures, or characteristics of any embodiment may be combined in any suitable manner with one or more other features, structures, or characteristics of one or more other embodiments without limitation.

Although one or more embodiments of the present invention have been described in some detail for clarity of understanding, it will be apparent that certain changes and modifications may be made within the scope of the various embodiments. Accordingly, the described embodiments are to be considered as illustrative and not restrictive, and the scope of the various embodiments is not to be limited to details given herein, but may be modified. In the various embodiments, elements and/or any described steps do not imply any particular order of operation, unless explicitly stated therein.

It should be noted that the process of combustion is integral to many types of combustion engines including, but not limited to, rocket engines. The process of combustion is commonly defined as either a “deflagration” or as a “detonation”.

In a deflagration combustion, the combustion wave which is generated will typically have a maximum velocity which is deeply sub-sonic. Furthermore, a deflagration combustion typically generates a blast overpressure of significantly less than 20 times the initial combustion pressure. Hence, the deflagration combustion process is sometimes referred to as being approximately an isobaric combustion.

In a detonation combustion, flame velocities typically reach supersonic speeds and, in fact, can reach speeds on the order of several thousand meters per second. Additionally, detonation combustion processes are capable of generating an overpressure which can significantly exceed 20-100 times the initial combustion pressure. Thus, the detonation combustion process is sometimes referred to as being an approximately isochoric combustion. Moreover, when compared to deflagration, detonation has a faster heat release, a reduced entropy, and a greater thermal efficiency.

As a result of the advantageous characteristics of a detonation combustion, detonation-based propulsion engines (e.g., detonation-based rocket engines) have been developed. One type of detonation-based rocket engine is a rotating detonation engine (RDE), sometimes referred to as a continuously rotating detonation engine (CRDE). For purposes of brevity and clarity, the following description may refer to a rotating detonation engine, a rotating detonation rocket engine, or the like, when describing various embodiments of the present invention. It should be noted, however, that various embodiments of the present invention may be well suited to use in various other types of detonation-based propulsion engines.

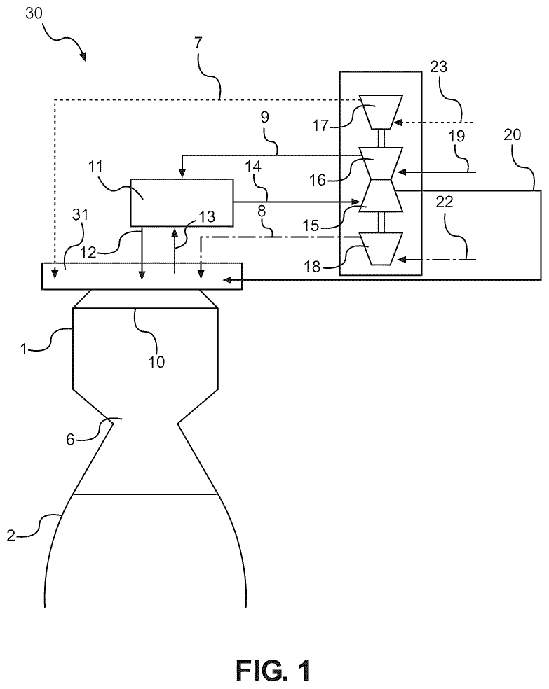

Referring now to FIGS. 1-4, in various embodiments, the present invention is an improved rocket engine system wherein the coolant is heated to a temperature and pressure such that the coolant is at a supercritical state, or the coolant is heated to a temperature and pressure which is below the temperature or pressure at which the coolant reaches a supercritical state, or the coolant is heated to a temperature and pressure which is above the temperature or pressure at which the coolant reaches a supercritical state according to embodiments of the present invention. A person of ordinary skill in the art will understands that the flow circuit shown in the various Figures is simplified so as not to obscure the invention with unnecessary detail. Additionally, it will further be understood by those of ordinary skill in the art that there are also a number of valves, ancillary lines, and by-pass pathways, which may not be shown in the Figures so as not to obscure the invention with unnecessary detail.

In various embodiments of the present invention, the coolant is solely or partially composed of, for example, non-reacting materials. Such non-reacting materials include, but are not limited to, for example, carbon dioxide (CO2), nitrogen (N2), or water (H2O). In various embodiments of the present invention, the coolant is solely or partially composed of, for example, reacting materials. Such reacting materials include, but are not limited to, for example, peroxide (H2O2), nitrous oxide (N20), ammonia (NH3), or propane (C3H8).

In various embodiments of the present invention, when the coolant is solely or partially composed of water, several advantages are realized. For example, when using water as a coolant, the presence of water will beneficially reduce or slow down the reaction kinetics of the fuel and the oxidizer thereby improving the performance of the rocket engine. Such a benefit is particularly important in detonation rocket engines as the reduction in the reaction kinetics enables more efficient mixing and subsequent detonation of, for example, the fuel and the oxidizer. Additionally, as the density of water is greater than the density of most conventional coolants, a given mass of water can be stored in a smaller (and correspondingly lighter) tank than is required to store the same mass of less-dense conventional coolants. Furthermore, the higher density of water compared to the density of conventional coolants results in an improved specific impulse (specific impulse is often denoted as Iₛₚ) when using water compared to the specific impulse corresponding to the use of less-dense conventional coolants. Also, water is much more readily available, much less toxic, and much less expensive than the availability, toxicity, and cost of many conventional coolants.

It should be noted that water can be used as the coolant in various embodiments of the present invention described below. It should further be noted that the following description of the various embodiments of the present invention are well suited, but not limited to, the various non-reacting materials and/or reacting coolants listed above.

Referring now to FIG. 1, in various embodiments of the present invention, the rocket engine system uses propellant that includes a fuel source stored in a vehicle or other structure coupled with the rocket engine. The fuel is delivered to the engine via the fuel feedline 23. An oxidizer source stored in the vehicle or other structure coupled to the rocket engine, delivers the oxidizer to the engine via the oxidizer feedline 22. Also, FIG. 1, schematically depicts a coolant source stored in a vehicle or other structure coupled with the rocket engine. The coolant is delivered to the engine via the coolant feedline 19. The coolant source is in communication with a pressurization system. In various embodiments, the present invention includes a turbine 15, coolant pump 16, fuel pump 17, and oxidizer pump 18. In various embodiments, the coolant pump 16 is in communication with a heat exchanger 11 via, for example, a high-pressure coolant line 9. In various embodiments, the fuel pump 17 is in communication with the injector manifold 10 through, for example, a fuel high-pressure fuel line 7. In various embodiments, the oxidizer pump 18 is in communication with the injector manifold 10 through, for example, a high-pressure oxidizer line 8.

In various embodiments of the present invention, the coolant temperature is increased in the heat exchanger 11 to a temperature and pressure such that the coolant is at a supercritical state (herein referred to as supercritical coolant). In various embodiments of the present invention, the coolant temperature is increased in the heat exchanger 11 to a temperature and pressure which is above the temperature or pressure at which the coolant is at a supercritical state (herein referred to as above-supercritical coolant). In various embodiments of the present invention, the coolant temperature is increased in the heat exchanger 11 to a temperature and pressure which is below the temperature or pressure at which the coolant is at a supercritical state (herein referred to as sub-supercritical coolant).

In various embodiments of the present invention, supercritical coolant is then in communication with coolant channels built into the outer wall 4 via, for example, a coolant heat exchanger outlet line 12. In one embodiment, the supercritical state is temperature and pressure just into the supercritical regime of the coolant used. For example, if water is used as the supercritical coolant, the temperature may be raised to between 374-392° C., and the pressure to between 220-231 bar. The coolant may thus be raised to a just-supercritical state, just above the critical pressure and temperature, where there is a significant increase in convective heat transfer due to the lower viscosity and higher conductivity of the fluid. The internal coolant channels are integrated into the wall via manifolds and passages as those skilled in the art are familiar with. The coolant cools the engine walls including the throat 6 and portion of the nozzle 2 before returning to the heat exchanger 11 via the hot coolant inlet 13. The coolant after exchanging heat with the incoming coolant, exits the heat exchanger 11 and enters the coolant turbine 15 via the hot coolant heat exchanger outlet 14. After the coolant provides the power for the pressurization system, the coolant enters the injector manifold 10 via the turbine outlet line 20, and enters the combustion chamber 1 with the fuel and propellant and exits the rocket engine through the throat 6.

In other embodiments of the present invention, sub-supercritical coolant is in communication with coolant channels built into the outer wall 4 via, for example, a coolant heat exchanger outlet line 12. For example, if water is used as the sub-supercritical coolant, the temperature may be raised to below 374-392° C., and/or the pressure is below between 220-231 bar such that the sub-supercritical coolant is, by the time it reaches the most critical point of the cooling passages (e. g., in a rotating detonation rocket engine (RDRE), abeam the detonation wave), raised to a just-supercritical state, just above the critical pressure and temperature, where there is a significant increase in convective heat transfer due to the lower viscosity and higher conductivity of the fluid. The internal coolant channels are integrated into the wall via manifolds and passages as those skilled in the art are familiar with. The coolant cools the engine walls including the throat 6 and portion of the nozzle 2 before returning to the heat exchanger 11 via the hot coolant inlet 13. The coolant after exchanging heat with the incoming coolant, exits the heat exchanger 11 and enters the coolant turbine 15 via the hot coolant heat exchanger outlet 14. After the coolant provides the power for the pressurization system, the coolant enters the injector manifold 10 via the turbine outlet line 20, and enters the combustion chamber 1 with the fuel and propellant and exits the rocket engine through the throat 6.

In other embodiments of the present invention, above-supercritical coolant is in communication with coolant channels built into the outer wall 4 via, for example, a coolant heat exchanger outlet line 12. For example, if water is used as the sub-supercritical coolant, the temperature may be raised to above 374-392° C., and/or the pressure is above between 220-231 bar. In such an embodiment, the above-supercritical coolant. The internal coolant channels are integrated into the wall via manifolds and passages as those skilled in the art are familiar with. The coolant cools the engine walls including the throat 6 and portion of the nozzle 2 before returning to the heat exchanger 11 via the hot coolant inlet 13. The coolant after exchanging heat with the incoming coolant, exits the heat exchanger 11 and enters the coolant turbine 15 via the hot coolant heat exchanger outlet 14. After the coolant provides the power for the pressurization system, the coolant enters the injector manifold 10 via the turbine outlet line 20 and enters the combustion chamber 1 with the fuel and propellant and exits the rocket engine through the throat 6.

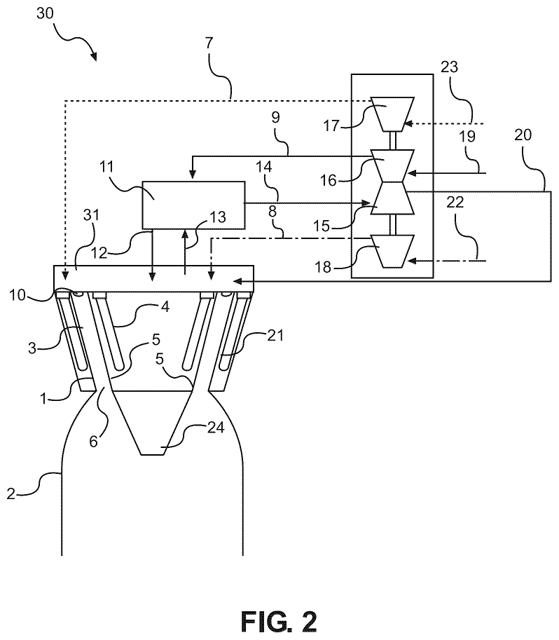

Referring now to FIG. 2, in various embodiments, the rocket engine system includes an aerospike nozzle 24 such that the combustion happens in an annulus 3 contained by an inner cowl 5 and outer cowl 1. In various embodiments, the aerospike nozzle 24 may also be any altitude-compensating nozzle, such as, but not limited to, a plug nozzle, an expanding nozzle, a single expansion ramp nozzle, a stepped nozzle, an expansion deflection nozzle, or an extending nozzle.

In various embodiments, for example, where the rocket engine system has an aerospike nozzle and the rocket engine is a rotating detonation rocket engine and there is an increased yet localized heat load near the injection point, the sub-supercritical coolant is introduced to the rocket engine at the area of localized heat load such that the sub-supercritical coolant heated to a supercritical state by the area of localized heat load to augment cooling of the rocket engine.

In various embodiments of the present invention, there are coolant channels 4 in the inner cowl 5 and coolant channels 21 in the outer cowl 1. Coolant (supercritical coolant, sub-supercritical coolant or above-supercritical coolant) from the heat exchanger outlet 12 first cools the inner cowl 5 via coolant channels 4 before returning to the heat exchanger 11 via the hot coolant heat exchanger inlet 13 as “hot coolant”. The hot coolant, after exchanging heat with the incoming coolant, exits the heat exchanger 11 and enters the coolant turbine 15 via the hot coolant heat exchanger outlet 14. After the turbine 15 the coolant returns to the aerospike engine and cools the outer cowl 1 via coolant channels 21. The coolant channels 4 and 21 are integrated into the cowls via manifolds and passages as those skilled in the art are familiar with. After the coolant provides the power for the pressurization system, the coolant enters the injector manifold 10 via the turbine outlet line 20, and enters the combustion chamber annulus 3 with the fuel and propellant and exits the rocket engine through the throat 6.

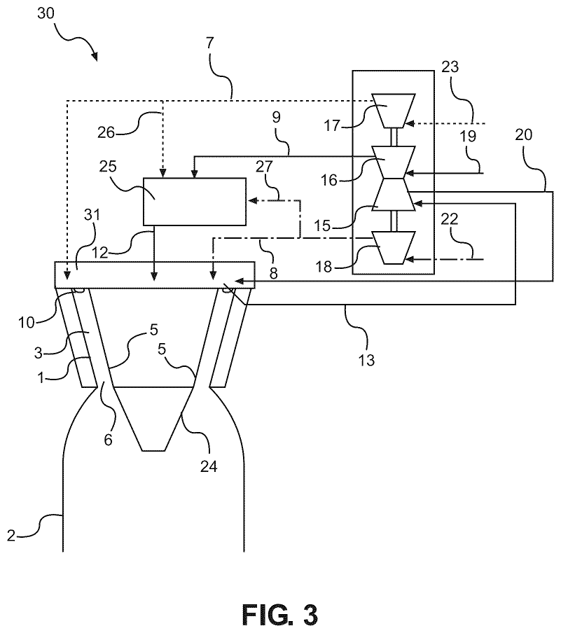

Referring now to FIG. 3, in various embodiments of the present invention, the rocket engine system uses a preburner 25 to add heat to the coolant (supercritical coolant, sub-supercritical coolant or above-supercritical coolant), completely or temporarily, for example just for startup, replacing or contributing to a heat exchanger. In various embodiments, fuel is diverted to the preburner from the high-pressure fuel line 7 via the fuel preburner inlet 26, and oxidizer is diverted to the preburner from the high-pressure oxidizer line 8 via the oxidizer preburner inlet 27.

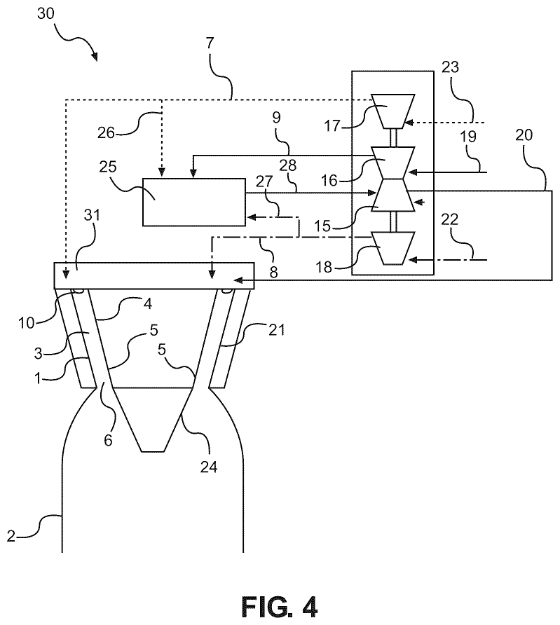

Referring now to FIG. 4, in various embodiments of the present invention, the rocket engine system uses a preburner 25 that powers the pressurization system and then is mixed with the coolant (supercritical coolant, sub-supercritical coolant or above-supercritical coolant) in the preburner 25 before powering the turbopump 15 via the turbine inlet line 28 before cooling the rocket engine via the engine coolant line 20.

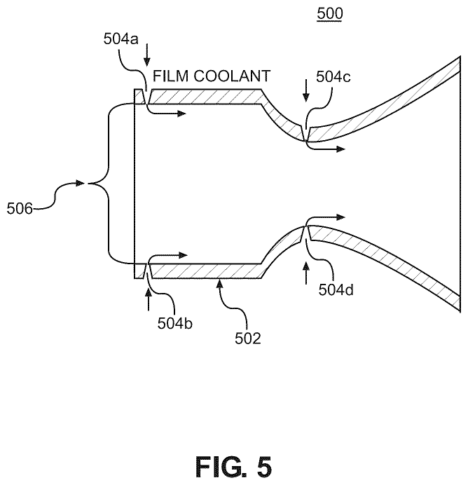

Referring now to FIG. 5, a schematic cut-away view 500 is provided depicting an embodiment of an improved rocket engine system. As shown in FIG. 5, coolant is applied to the rocket engine 502 to achieve film cooling of rocket engine 502, in accordance with embodiments of the present invention. In one embodiment of the present invention, the coolant is water. More specifically, in one embodiment, the water is applied to the interior surface of rocket engine 502. In various embodiments, by applying the water to the interior surface of rocket engine 502, the water provides film cooling and also provides a protective barrier to the interior surface of rocket engine 502. By providing a protective barrier, embodiments of the present invention produce a more reliable rocket engine. Specifically, the protective barrier provided by the present film cooling embodiments reduces the frequency to inspect, or even the need to replace, the combustion wall chambers of rocket engine 502. Hence, embodiments of the present invention are well suited to use with reusable rocket engines. That is, the various embodiments of the present invention can extend the life of a reusable rocket, and/or increase the number times that reusable rocket can be used.

Referring again to FIG. 5, as mentioned above, because the density of water is greater than the density of most conventional coolants, in various embodiments of the present invention, a given mass of water can be stored in a smaller (and correspondingly lighter) tank than is required to store the same mass of less-dense conventional coolants. Furthermore, as the higher density of water is greater than the density of many conventional coolants, embodiments of the present invention achieve in an improved specific impulse compared to the specific impulse corresponding to the use of less-dense conventional coolants (e. g., fuel, which is generally used in all rocket engines employing film cooling to date). Also, water coolant, as used in various embodiments of the present invention, is more readily available, less toxic, and less expensive than the availability, toxicity, and cost of many conventional coolants.

Referring still to FIG. 5, in various embodiments, the water is applied to the interior surface of rocket engine 502 at, or proximate, the combustion chamber 506. As stated previously, when using water as a coolant, the presence of water will beneficially reduce or slow down the reaction kinetics of the fuel and the oxidizer in combustion chamber 506, thereby improving the performance of rocket engine 502. Such a benefit is particularly important in detonation rocket engines as the reduction in the reaction kinetics enables more efficient mixing and subsequent detonation of, for example, the fuel and the oxidizer in the combustion chamber thereof.

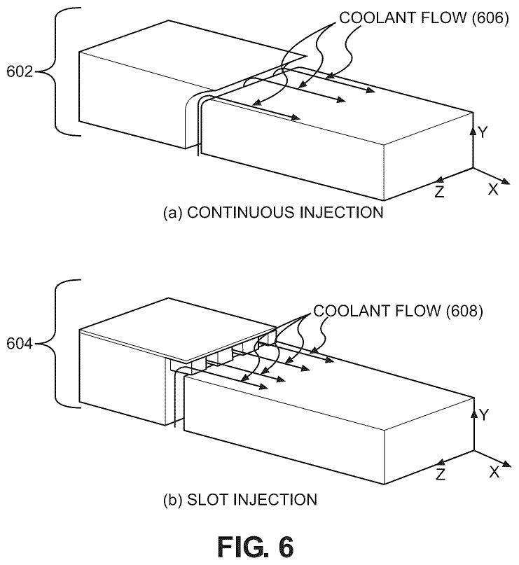

Still referring to FIG. 5, various ports 504a and 504b are located at, or proximate, the combustion chamber 506. FIG. 5 further depicts ports 504c and 504d. FIG. 6, to be discussed below, provides a detailed depiction of exemplary port configurations used in accordance with various embodiments of the present invention. Returning to FIG. 5, the water is applied to the interior surface of rocket engine 502 using one or more of ports 504a, 504b, 504c and 504d. Additionally, it should be noted that the various embodiments of the present invention are well suited to having a greater or lesser number of ports. The various embodiments of the present invention are also well suited to having the ports disposed at locations other than the locations depicted in FIG. 5.

Referring again to FIG. 5, it should be further noted that the film cooling embodiments corresponding to FIG. 5 are also well suited to being used in combination with any of the interior wall cooling embodiments described in detail above and corresponding to FIGS. 1-4. Furthermore, the film cooling embodiments of FIG. 5 are also well suited to being used in combination with ablative layers or other rocket engine cooling methodologies.

Although the above description of the embodiments of FIG. 5 (including the embodiments used in combination with the embodiments pertaining to FIGS. 1-4), specifically describes the use of water as the coolant, those various embodiments are also well suited to use with a coolant which is solely or partially composed of, for example, non-reacting materials other than water. Such non-reacting materials include, but are not limited to, for example, carbon dioxide (CO2), nitrous oxide (N2O) or nitrogen (N2). Additionally, the various embodiments corresponding to FIG. 5 (including the embodiments used in combination with the embodiments pertaining to FIGS. 1-4) are also well suited to use with a coolant which is solely or partially composed of, for example, reacting materials. Such reacting materials include, but are not limited to, for example, peroxide (H2O2), ammonia (NH3), or propane (C3H8).

Referring again to FIG. 5, in various embodiments of the present invention, the water is at a temperature and pressure such that the water is at supercritical state when applied to the interior surface of rocket engine 502. In various other embodiments of the present invention, the water is at a temperature and pressure which is above the temperature or pressure at which the water is at a supercritical state when applied to the interior surface of rocket engine 502. Moreover, in various embodiments of the present invention, the water is at a temperature and pressure which is below the temperature or pressure at which the coolant is at a supercritical state when applied to the interior surface of rocket engine 502. In such embodiments of the present invention, once the water is applied to the interior surface of the rocket engine, the water temperature or pressure is adjusted (i. e., increased or decreased) such that the temperature and pressure of the water corresponds to the supercritical state for water. For example, when water is introduced to the interior surface of rocket engine 502, at a sub-supercritical state or an above-supercritical state, the temperature of the water is adjusted, by the interior surface of rocket engine 502, to reach a range of approximately 374-392° C., and/or the pressure is adjusted to reach a pressure of between 220-231 bar at the point where maximum heat is being generated (e.g., in a RDE, adjacent to the detonation wave). In such an embodiment, the temperature and pressure of the water is thus adjusted to a supercritical state, where there is a significant increase in convective heat transfer due to the lower viscosity and higher conductivity of water when in a supercritical state.

Referring again to FIG. 5, in various embodiments, such as, for example, where the rocket engine system has an aerospike nozzle and the rocket engine is a rotating detonation rocket engine and there is an increased yet localized heat load near the injection point, the embodiments of the present invention inject the water onto the interior surface of rocket engine 502 at the area of localized heat to augment cooling of rocket engine 502.

With reference now to FIG. 6, a perspective view is provided of a continuous injection port 602 and a slot injection port 604 used to apply coolant (e. g., but not limited to, water) to the interior surface of rocket engine 502 (of FIG. 5), as described in conjunction with the embodiments of FIG. 5. As shown in FIG. 6, continuous injection port 602 is configured to distribute a substantially continuous stream of coolant, such as, but not limited to, water, onto the interior surface of rocket engine 502. Arrows 606 depict the flow direction of coolant along the interior surface of rocket engine 502. Similarly, in FIG. 6, slot injection port 604 is configured to distribute a non-continuous stream of coolant, such as, but not limited to, water, onto the interior surface of rocket engine 502. Arrows 608 depict the flow direction of coolant along the interior surface of rocket engine 502. Although a continuous injection port 602 and a slot injection port 604 are shown in FIG. 6, embodiments of the present invention are well suited to use with various other features, ports, and port shapes, types and configurations to enable the application of a coolant, such as, but not limited to, water, onto the interior surface of rocket engine 502.

The convection heat flux, q=hΔT, into the coolant is proportional to the convection coefficient hand temperature difference, ΔT=Tcombustion−Tcoolant. In a supercritical state, the convection coefficient, h, increases significantly due to decreased viscosity and increased thermal conductivity of the coolant. The total heat transfer increases, even though the coolant temperature, Tcoolant, has increased giving a subsequent decrease in ΔT. Thus, the rocket engine can be cooled much more effectively and efficiently.

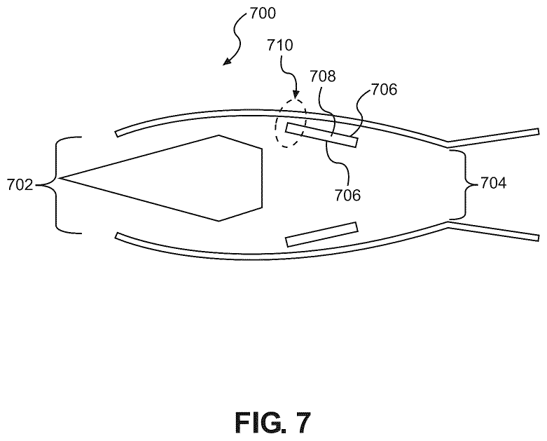

With reference now to FIG. 7, a schematic cut-away view of a rotating detonation engine 700 is provided. As will be described below, various embodiments of the present invention will beneficially achieve cooling of rotating detonation engine 700 while also generating a secondary combustion to increase the thrust of rotating detonation engine 700. It should be noted that in FIG. 7, various well-known components and structures are not depicted in detail to prevent unnecessarily obscuring aspects of the various described embodiments of the present invention.

FIG. 7 schematically depicts an air inlet region 702 and a combustion chamber 704. It will be understood that air inlet region 702, in some embodiments, enables air to be directed to combustion chamber 704. As depicted in FIG. 7, combustion chamber 704 typically includes annular walls represented as 706 which define an annulus 708 in which detonation occurs. For purposes of clarity, walls 706 are schematically represented in FIG. 7. It should be noted that more detailed representations of such walls, and corresponding detailed descriptions thereof, are provided below.

Additionally, as will be described in detail below, in various embodiments of the present invention, combustion chamber 704 may include a plurality of annuli and a corresponding plurality of walls defining the plurality of annuli. In such embodiments, detonation may occur in one or more of the annuli. Furthermore, in embodiments of the present invention having a combustion chamber comprised of plurality of annuli, detonation may occur concurrently in more than one or even all of the plurality of annuli.

With reference still to FIG. 7, a region 710 is depicted. Region 710 is the portion of rotating detonation engine 700 at which coolant is provided to walls 706 as described above in conjunction with the embodiments of FIGS. 1-6. It should be noted that some embodiments of the present invention will include one or more of the structures, features and processes described in the embodiments corresponding to FIGS. 1-6 above. More specifically, some embodiments of the present invention will include, for example, a turbine 15, coolant pump 16, fuel pump 17, and oxidizer pump 18 all of FIG. 1. Furthermore, in various embodiments of the present invention, the coolant pump 16 is in communication with a heat exchanger 11 via, for example, a high-pressure coolant line 9. Moreover, in various embodiments, the fuel pump 17 is in communication with the injector manifold 10 through, for example, a fuel high-pressure fuel line 7. In various embodiments, the oxidizer pump 18 is in communication with the injector manifold 10 through, for example, a high-pressure oxidizer line 8. For purposes of brevity and clarity, portions of the detailed description of the structures, features and processes of the embodiments previously described in conjunction with FIGS. 1-6 are not repeated in their entirety below.

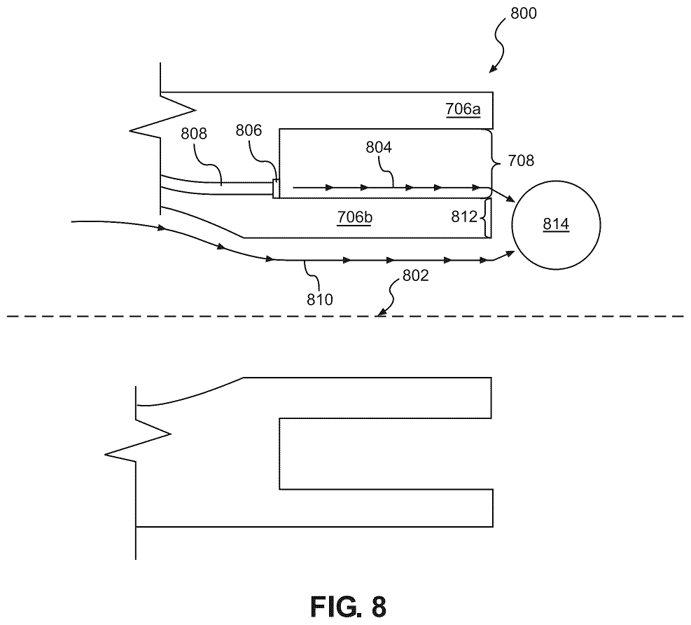

Referring now to FIG. 8, a cut-away view 800 of walls 706 including region 710, both of FIG. 7, is provided. For clarity, as walls 706 are annular and as FIG. 8 is a cut-away view, a line of symmetry 802 is provided to illustrate the symmetric orientation of the features of depicted in FIG. 8. Additionally, in FIG. 8, walls 706 are shown in detail to clearly illustrate that two portions 706a and 706b define annulus 708 in which detonation occurs.

In embodiments of the present invention, fuel is applied to the interior side (i.e., the side closest to annulus 708) of wall 706b. More particularly, in various embodiments, fuel is provided via port 806 and channel 808 to enable film cooling, via the provided fuel, along the interior side of wall 706b. Embodiments of the present invention are well suited to use with various other features, cooling channels, port shapes, port types and port configurations, as described, for example, above in accordance with the detailed description of the embodiments of FIGS. 1-6, to enable the application of the coolant fuel onto the interior surface of wall 706b. The direction of flow of the fuel as it provides film cooling is depicted by line 804 in FIG. 8. In various embodiments, by applying fuel to the interior side of wall 706b, the fuel provides film cooling while also providing a protective barrier to the interior side of wall 706b. By providing a protective barrier, embodiments of the present invention produce a more reliable rocket engine. Specifically, the protective barrier provided by the fuel, and the corresponding film cooling of the interior side of wall 706b, reduces the frequency to inspect, or even the need to replace, wall 706b. Hence, embodiments of the present invention are well suited to use with reusable rocket engines. That is, the various embodiments of the present invention can extend the life of a reusable rocket, and/or increase the number times that reusable rocket can be used.

Referring still to FIG. 8, various embodiments of the present invention also provide an oxidizer along, for example, the exterior side (i.e., the side farthest from annulus 708) of wall 706b. The direction of flow of the oxidizer along the exterior surface of wall 706b is depicted by line 810 in FIG. 8. More particularly, in various embodiments, the oxidizer is provided via a port or ports, not shown. Furthermore, embodiments of the present invention are well suited to use with various other features, cooling channels, port shapes, port types, and port configurations, as described above in detail in accordance with the embodiments of FIGS. 1-6, to provide the oxidizer along the exterior surface of wall 706b. It should be noted that embodiments of the present invention are also well suited to use with various oxidizers including, but not limited to, air, liquid oxygen, hydrogen peroxide, and the like. Also, in various embodiments of the present invention, providing a flow of oxidizer along the exterior surface of wall 706b, as depicted by line 810, will cool wall 706b.

With reference again to FIG. 8, in various embodiments of the present invention, the oxidizer is at least partially comprised of air which is received, for example, at air inlet region 702 of FIG. 7, and then directed along the exterior surface of wall 706b, as depicted by line 810. In various embodiments, the air may be received, for example, at air inlet region 702 at subsonic or supersonic speeds. In some embodiments of the present invention, the flow rate of the air along line 810 is adjusted to achieve a desired air flow velocity. Additionally, in various embodiments, of the present invention, the oxidizer may be comprised of more than one oxidizing agent. As one example, air received at a supersonic speed may actually generate heat when directed along the exterior surface of wall 706b. In such an instance, embodiments of the present invention will also supply, for example, liquid oxygen along with the received air to ensure proper temperature management of exterior surface of wall 706b.

Referring still to FIG. 8, in embodiments of the present invention, the fuel used for film cooling of interior surface 706b and the oxidizer directed along the exterior surface of wall 706b will combine after they pass the rear edge 812 of wall 706b. A circle 814 is shown in FIG. 8 to figuratively depict a region at which the coolant fuel and the oxidizer combine. It should be noted that circle 814 is merely a graphical representation of the combination of the coolant fuel and the oxidizer, and that the combination of the coolant fuel and the oxidizer can occur at a region other than within or near circle 814.

Referring again to FIG. 8, in various embodiments of the present invention, once the fuel used for film cooling of interior surface 706b and the oxidizer directed along the exterior surface of wall 706b have passed the rear edge 812 of wall 706b, and have combined, a secondary combustion is generated. In embodiments of the present invention, the secondary combustion will occur due to sources of ignition readily present outside of annulus 708.

With reference again to FIG. 8, it will be understood that specific impulse (commonly abbreviated as Iₛₚ) is an important factor when determining the efficiency of the thrust generated by, for example, a rotating detonation rocket engine. More particularly, the Iₛₚ value is a measurement of how efficiently a reaction mass engine, for example rotating detonation rocket engine 700 of FIG. 7, creates thrust from its fuel or other propellant. In embodiments of the present invention, the secondary combustion of the coolant fuel and the oxidizer generates additional thrust for rotating detonation rocket engine 700. As a result, embodiments of the present invention increase the efficiency, the Iₛₚ value, of rotating detonation rocket engine 700. Moreover, embodiments of the present invention beneficially and uniquely obtain a “two-for-one” advantage by first using the coolant fuel for film cooling and secondly using the same coolant fuel to generate a secondary combustion and corresponding additional thrust. Thus, embodiments of the present invention, unlike conventional film cooling approaches, do not merely expel or waste film coolant. Instead, embodiments of the present invention are able to cool surfaces within annulus 708 without wasted payload, wasted propellant, or impeding propellant flow through annulus 708. Further, embodiments of the present invention the obtain additional thrust from the coolant fuel via the secondary combustion. As stated previously, for purposes of brevity and clarity, portions of the present detailed description refer to a rotating detonation engine, a rotating detonation rocket engine, or the like, when describing various embodiments of the present invention. It should again be noted, however, that various embodiments of the present invention are well suited to use in various other types of detonation-based propulsion engines. Further, in various embodiments of the present invention, the combination of coolant fuel and oxidizer only occurs after the coolant fuel is no longer within annulus 708. That is, in embodiments of the present invention, the coolant fuel is utilized for film cooling within annulus 708, and the coolant fuel is used for a secondary combustion when no longer within annulus 708 (e.g., beyond rear edge 812 of wall 706b).

In embodiments of the present invention, the amount of coolant fuel and the amount of oxidizer are controlled to ensure that the stoichiometry between the coolant fuel and oxidizer is appropriate for combustion. More specifically, in embodiments of the present invention, the flow rate or volume of the coolant fuel and/or the flow rate or volume of the oxidizer are adjusted to ensure that, upon combination, the resulting stoichiometry of coolant fuel and oxidizer is suitable for combustion. As one example, when air is being used as the oxidizer, as the altitude and/or the velocity in which of rotating detonation engine 700 changes, the flow rate or volume of the coolant fuel and/or the flow rate or volume of the oxidizer are adjusted to ensure that, upon combination, the resulting stoichiometry of coolant fuel and oxidizer is suitable for combustion.

In one embodiment of the present invention, where a surplus of oxidizer is already present after detonation occurs in annulus 708, only the flow rate or volume of the coolant fuel may need to be adjusted to ensure that the combination of coolant fuel and oxidizer (beyond rear edge 812 of wall 706b) has a stoichiometry suitable for the secondary combustion. Similarly, in one embodiment of the present invention, where a surplus of coolant fuel is already present after detonation in annulus 708, only the flow rate or volume of the oxidizer may need to be adjusted to ensure that the combination of coolant fuel and oxidizer (beyond rear edge 812 of wall 706b) has a stoichiometry suitable for the secondary combustion. As yet another example, if air is being used as an oxidizer, and the air flow rate or volume is insufficient, when combined with the coolant fuel, to achieve a combustible stoichiometry, embodiments of the present invention will also supply, for example, liquid oxygen along with the received air to ensure the proper combustible stoichiometry upon combination beyond rear edge 812 of wall 706b. Hence, embodiments of the present invention differ from other film cooling approaches in that the various embodiments of the present invention adjust the flow rate or volume of the coolant fuel and/or adjust the flow rate or volume of the oxidizer to ensure that the combination of coolant fuel and oxidizer (beyond rear edge 812 of wall 706b) has a stoichiometry suitable for the secondary combustion.

Referring still to FIG. 8, embodiments of the present invention are also well suited to use in combination with various other cooling methodologies such as, but not limited to, the cooling methodologies described above in detail in accordance with the embodiments of FIGS. 1-6. For example, in some embodiments of the present invention, wall 706a is cooled as described in the embodiments corresponding to FIGS. 1-6, while wall 706b is treated as described in the embodiments corresponding to FIGS. 7-8.

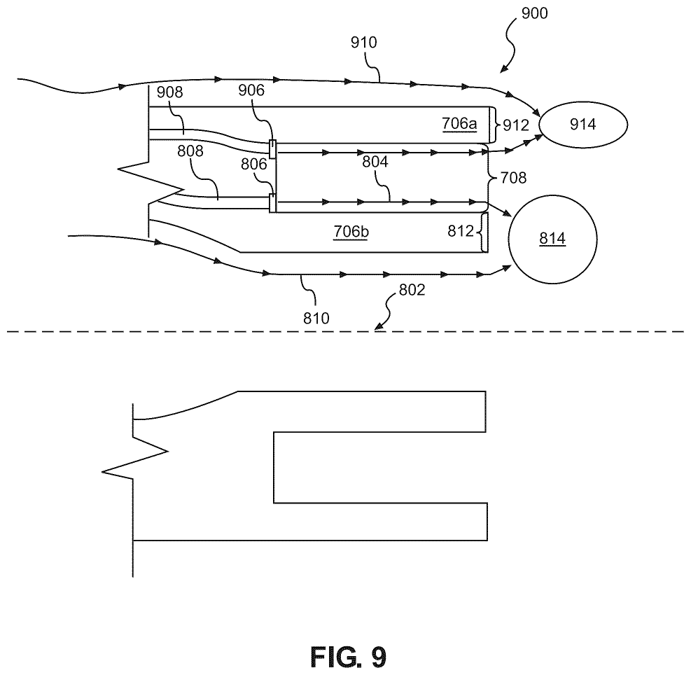

Referring now to FIG. 9, a cut-away view 900 of walls 706a and 706b in which both wall 706a and wall 706b as described in the embodiments corresponding to FIGS. 7-8. It will be understood that in the embodiment of FIG. 9, wall 706b is treated as described in the embodiments corresponding to FIGS. 7-8. For purposes of brevity and clarity, the discussion of wall 706b and the embodiments corresponding to FIGS. 7-8 is not repeated here. Furthermore, in the present embodiment, wall 706a is treated in the same or similar manner as was described for wall 706b in the embodiments corresponding to FIGS. 7-8. Once again, for purposes of brevity and clarity, the discussion of wall 706a and the embodiments corresponding to FIG. 9 will not repeat the entirety of the discussion corresponding to the embodiments of FIGS. 7-8. It should be noted, however, that the various embodiment variations mentioned in the discussion corresponding to FIGS. 7-8 also apply to the embodiment of FIG. 9. With reference to wall 706a, in embodiments of the present invention, fuel is applied to the interior side (i.e., the side closest to annulus 708) of wall 706a. More particularly, in various embodiments, fuel is provided via port 906 and channel 908 to enable film cooling, via the provided fuel, along the interior side of wall 706a. Embodiments of the present invention are well suited to use with various other features, cooling channels, port shapes, port types and port configurations, as described, for example, above in accordance with the detailed description of the embodiments of FIGS. 1-6, to enable the application of the coolant fuel onto the interior surface of wall 706a. The direction of flow of the fuel as it provides film cooling is depicted by line 904 in FIG. 9. In various embodiments, by applying fuel to the interior side of wall 706a, the fuel provides film cooling while also providing a protective barrier to the interior side of wall 706a.

Referring still to FIG. 9, various embodiments of the present invention also provide an oxidizer along, for example, the exterior side (i.e., the side farthest from annulus 708) of wall 706a. The direction of flow of the oxidizer along the exterior surface of wall 706a is depicted by line 910 in FIG. 9. More particularly, in various embodiments, the oxidizer is provided via a port or ports, not shown. Furthermore, embodiments of the present invention are well suited to use with various other features, cooling channels, port shapes, port types, and port configurations, as described above in detail in accordance with the embodiments of FIGS. 1-6, to provide the oxidizer along the exterior surface of wall 706a. It should be noted that embodiments of the present invention are also well suited to use with various oxidizers including, but not limited to, air, liquid oxygen, hydrogen peroxide, and the like. Also, in various embodiments of the present invention, providing a flow of oxidizer along the exterior surface of wall 706a, as depicted by line 910, will cool wall 706a.

Referring still to FIG. 9, in embodiments of the present invention, the fuel used for film cooling of interior surface 706a and the oxidizer directed along the exterior surface of wall 706a will combine after they pass the rear edge 912 of wall 706a. A circle 914 is shown in FIG. 9 to figuratively depict a region at which the coolant fuel and the oxidizer combine. It should be noted that circle 914 is merely a graphical representation of the combination of the coolant fuel and the oxidizer, and that the combination of the coolant fuel and the oxidizer can occur at a region other than within or near circle 914.

Referring again to FIG. 9, in various embodiments of the present invention, once the fuel used for film cooling of interior surface 706a and the oxidizer directed along the exterior surface of wall 706a have passed the rear edge 912 of wall 706a, and have combined, a secondary combustion is generated. In embodiments of the present invention, the secondary combustion will occur due to sources of ignition readily present outside of annulus 708. Hence, in the embodiment of FIG. 9, there are two secondary combustions. It should further be noted that embodiments of the present invention are also well suited to use in detonation-based propulsion engines having a plurality of annuli.

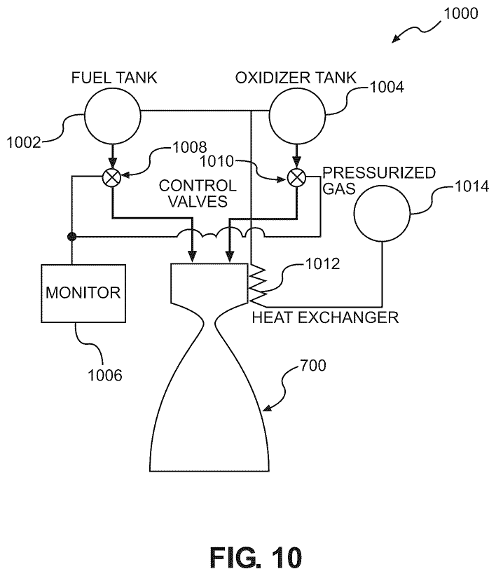

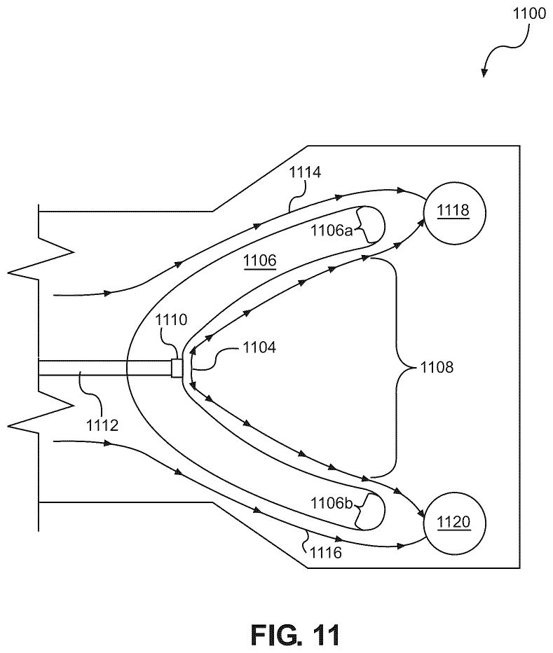

Referring now to FIG. 10, a schematic diagram 1000 is provided depicting various components of a system in accordance with embodiments of the present invention. The components of schematic diagram 1000 are used, for example, in accordance with the with the embodiments described above in conjunction with FIGS. 7-9. Further, the components of schematic diagram 1000 are used, for example, in accordance with the with the embodiments described below in conjunction with FIG. 11.

Referring still to FIG. 10, in accordance with embodiments of the present invention, the system is comprised of a fuel tank 1002 for providing coolant fuel and an oxidizer tank 1004 for providing oxidizer. Additionally, in embodiments of the present invention, the system also includes a monitor 1006 coupled to control valves 1008 and 1010. In various embodiments, monitor 1006 utilizes control valves 1008 and 1010 to ensure that amount of coolant fuel and the amount of oxidizer have the necessary stoichiometry appropriate for the secondary combustion to occur in, for example, rotating detonation engine 700. In various embodiments, the present invention further includes a heat exchanger 1012 and a source of pressurized gas 1014.

Referring now to FIG. 11, a cut-away view 1100 of a combustion chamber wall 1106 of a propulsion engine. In embodiments of the present invention, fuel is applied to the interior side (i.e., the side closest to combustion region 1108) of wall 1106. More particularly, in various embodiments, fuel is provided via port 1110 and channel 1112 to enable film cooling, via the provided fuel, along the interior side of wall 1106. Embodiments of the present invention are well suited to use with various other features, cooling channels, port shapes, port types and port configurations, as described, for example, above in accordance with the detailed description of the embodiments of FIGS. 1-6, to enable the application of the coolant fuel onto the interior surface of wall 1106. The direction of flow of the coolant fuel as it provides film cooling is depicted by line 1104 in FIG. 11. In various embodiments, by applying fuel to the interior side of wall 1106, the fuel provides film cooling while also providing a protective barrier to the interior side of wall 1106. By providing a protective barrier, embodiments of the present invention produce a more reliable rocket engine. Specifically, the protective barrier provided by the fuel, and the corresponding film cooling of the interior side of wall 1106, reduces the frequency to inspect, or even the need to replace, wall 1106. Hence, embodiments of the present invention are well suited to use with reusable rocket engines. That is, the various embodiments of the present invention can extend the life of a reusable rocket, and/or increase the number times that reusable rocket can be used.

Referring still to FIG. 11, various embodiments of the present invention also provide an oxidizer along, for example, the exterior side (i.e., the side farthest from combustion chamber 1108) of wall 1106. The direction of flow of the oxidizer along the exterior surface of wall 1106 is depicted by lines 1114 and 1116 in FIG. 11. More particularly, in various embodiments, the oxidizer is provided via a port or ports, not shown. Furthermore, embodiments of the present invention are well suited to use with various other features, cooling channels, port shapes, port types, and port configurations, as described above in detail in accordance with the embodiments of FIGS. 1-6, to provide the oxidizer along the exterior surface of wall 1106. It should be noted that embodiments of the present invention are also well suited to use with various oxidizers including, but not limited to, air, liquid oxygen, hydrogen peroxide, and the like. Also, in various embodiments of the present invention, providing a flow of oxidizer along the exterior surface of wall 1106, as depicted by lines 1114 and 1116, will cool wall 1106.

With reference again to FIG. 11, in various embodiments of the present invention, the oxidizer is at least partially comprised of air which is received, for example, at an air inlet region of rocket, and then directed along the exterior surface of wall 1106, as depicted by lines 1114 and 116. Additionally, in various embodiments, of the present invention, the oxidizer may be comprised of more than one oxidizing agent. As described above in detail, in various embodiments, the amount of coolant fuel and the amount of oxidizer are controlled to ensure that the stoichiometry between the coolant fuel and oxidizer is appropriate for the secondary combustion.

Referring still to FIG. 11, in embodiments of the present invention, the fuel used for film cooling of interior surface 1106 and the oxidizer directed along the exterior surface of wall 1106 will combine after they pass the rear edges 1106a and 1106b of wall 1106. Circles 1118 and 1120 are shown in FIG. 11 to depict the regions at which the coolant fuel and the oxidizer combine. It should be noted that circles 1118 and 1120 are merely a graphical representation of the combination of the coolant fuel and the oxidizer, and that the combination of the coolant fuel and the oxidizer can occur at regions other than within or near circles 1118 and 1120.

Furthermore, in the present embodiment, wall 1106 is treated in the same or similar manner as was described for wall 706b in the embodiments corresponding to FIGS. 7-9. Once again, for purposes of brevity and clarity, the discussion of wall 1106 and the embodiments corresponding to FIG. 11 will not repeat the entirety of the discussion corresponding to the embodiments of FIGS. 7-9. It should be noted, however, that the various embodiment variations mentioned in the discussion corresponding to FIGS. 7-9 also apply to the embodiment of FIG. 11.

Referring again to FIG. 11, in various embodiments of the present invention, once the fuel used for film cooling of interior surface 1106 and the oxidizer directed along the exterior surface of wall 1106 have passed the rear edges 1106a and 1106b of wall 1106, and have combined, a secondary combustion is generated. In embodiments of the present invention, the secondary combustion will occur due to sources of ignition readily present outside of combustion chamber 1108.

Referring again to FIG. 11, in other embodiments, the oxidizer is comprised of liquid peroxide. Moreover, the liquid peroxide is also used as a film coolant. Additionally, in various embodiments, the products (oxygen and water) of the decomposed liquid peroxide are then used in the combustion chamber to oxidize the fuel. That is, in various embodiments of the present invention, providing a flow of liquid peroxide along the exterior surface of wall 1106, as depicted by lines 1114 and 1116, will cool wall 1106. It should be noted that the use of liquid peroxide as a coolant is counterintuitive. Specifically, one of ordinary skill in the art would not consider using liquid peroxide as a coolant due to the fact that the decomposition of liquid peroxide (into oxygen and water) is exothermic. Under certain conditions, the exothermic decomposition of liquid peroxide can generate temperatures of approximately 1400° F. As will be described below, despite the exothermic decomposition of liquid peroxide, embodiments of the present invention beneficially utilize liquid peroxide as an oxidizer and as a coolant. Further, it should be noted that detonation chamber temperatures of approximately 6000° F. are still readily cooled using embodiments of the present invention.

In various embodiments of the present invention, the novel use of liquid peroxide as an oxidizer and coolant has additional advantages. For example, the exothermic decomposition of liquid peroxide also increases pressure near, for example, wall 1106. The increased pressure, in turn, inhibits combustion products from contacting wall 1106. Further, the increased pressure improves the adherence of the liquid peroxide (and/or the liquid peroxide decomposition products) to wall 1106. The increased pressure also extends the area over which the liquid peroxide (and/or the liquid peroxide decomposition products) adhere to wall 1106. As a result, embodiments of the present invention extend the range or area of, for example, combustion chamber 704 of FIG. 7, over which film cooling is effective.

In some embodiments of the present invention, the decomposition of the liquid peroxide is achieved using a catalyst. In other embodiments, the decomposition of the liquid peroxide is achieved without using a catalyst. Further, in various embodiments, the decomposition of the liquid peroxide occurs before the liquid peroxide reaches the walls, while in other embodiments, the decomposition of the liquid peroxide occurs as the liquid peroxide contacts the walls or after travelling along the walls.

Various embodiments of the present invention also provide the liquid peroxide along, for example, the exterior side (i.e., the side farthest from combustion chamber 1108) of wall 1106. The direction of flow of the liquid peroxide along the exterior surface of wall 1106 is depicted by lines 1114 and 1116 in FIG. 11. More particularly, in various embodiments, the liquid peroxide is provided via a port or ports, not shown. Furthermore, embodiments of the present invention are well suited to use with various other features, cooling channels, port shapes, port types, and port configurations, as described above in detail in accordance with the embodiments of FIGS. 1-6, to provide the liquid peroxide along the exterior surface of wall 1106.

With reference again to FIG. 11, as described above in detail, in various embodiments, the amount of liquid peroxide is controlled to ensure that, for example, the fuel and the liquid peroxide (and/or the liquid peroxide decomposition products) ultimately result in a stoichiometry that is appropriate for a secondary combustion.

Referring still to FIG. 11, in embodiments of the present invention, components such as, for example, fuel, coolant fuel, liquid peroxide, and the components of the decomposed liquid peroxide will combine after they pass the rear edges 1106a and 1106b of wall 1106. Circles 1118 and 1120 are shown in FIG. 11 to depict the regions at which the components combine. It should be noted that circles 1118 and 1120 are merely a graphical representation of the combination of the components, and that the combination of the components can occur at regions other than within or near circles 1118 and 1120.

Furthermore, in the present embodiment, wall 1106 is treated in the same or similar manner as was described for wall 706b in the embodiments corresponding to FIGS. 7-9. Once again, for purposes of brevity and clarity, the discussion of wall 1106 and the embodiments corresponding to FIG. 11 will not repeat the entirety of the discussion corresponding to the embodiments of FIGS. 7-9. It should be noted, however, that the various embodiment variations mentioned in the discussion corresponding to FIGS. 7-9 also apply to the embodiment of FIG. 11.

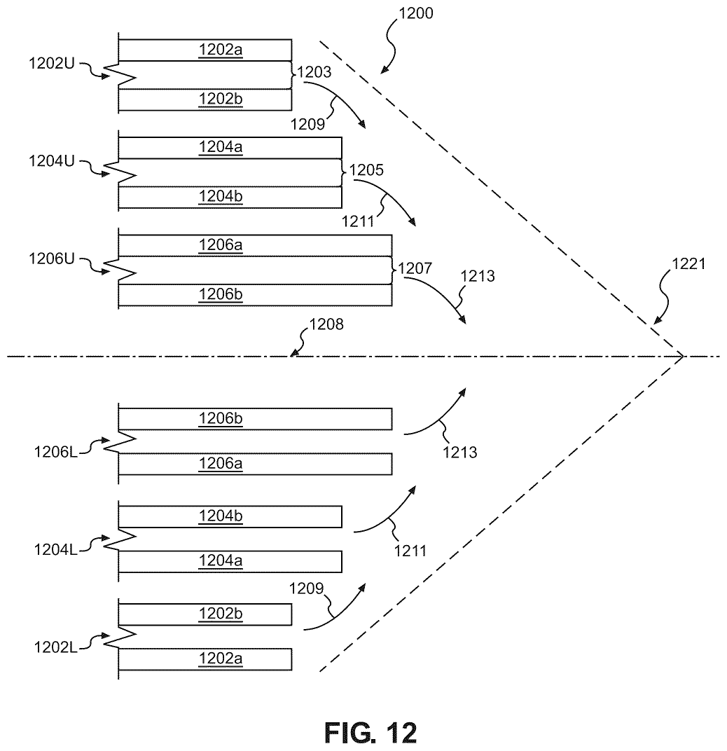

With reference next to FIG. 12, a cross-sectional view of a series of nested annuli 1200 is provided in accordance with embodiments of the present invention. For purposes of the present discussion, the terms “nested annuli” is intended to refer to a structure wherein at least a portion of a first annulus is surrounded by at least a portion of a second annulus. Furthermore, it will be understood that an annulus is typically defined, for example, in geometry, as the region between two concentric circles having differing radii. In the RDRE field, the term annulus is understood, and used by those in the art, to typically refer to an annular channel or, more generally, to a detonation chamber around which one or more detonations continuously travel. For purposes of the present RDRE-based discussion, the word “annulus” may also refer to a cylindrical annular region which is disposed between, or bounded by, two cylinders. Additionally, as is understood and used by those in the RDRE art, an RDRE “annulus” is sometimes considered to include the outer wall and the inner wall in addition to the region (or detonation chamber) existing therebetween.

Three concentric annuli (1202, 1204 and 1206) are shown in FIG. 12, again for brevity and clarity. It should be noted, however, that in other embodiments of the present invention, series of nested annuli 1200 is comprised of as few as two annuli. Furthermore, in other embodiments of the present invention, series of nested annuli 1200 has more than three nested annuli. It should be noted that, for brevity and clarity, the following discussion will refer to embodiments in which series of nested annuli 1200 is comprised of concentric annuli. However, in various other embodiments of the present invention, at least one of the nested RDRE annuli comprising series of nested annuli 1200 is not concentric with at least one other annulus of series of nested annuli 1200. The following examples and discussions are not intended to limit the embodiments of the present invention solely to a plurality of concentric RDRE annuli.

As FIG. 12 is a cross-sectional view taken vertically through series of nested annuli 1200, for clarity, the upper portion of each of the concentric annuli of FIG. 12, with respect to line 1208, is designated with a U for upper. Conversely, the lower portion of each of the concentric annuli, as shown in FIG. 12 with respect to line 1208, is designated with an L for lower. Hence, it will be understood that annulus 1202, defined by of outer wall 1202a and inner wall 1202b, is denoted as 1202U above line 1208 and by 1202L below line 1208. Similarly, in FIG. 12, annulus 1204, defined by outer wall 1204a and inner wall 1204b, is denoted as 1204U above line 1208 and by 1204L below line 1208. Additionally, in FIG. 12, annulus 1206, defined by outer wall 1206a and inner wall 1206b, is denoted as 1206U above line 1208 and by 1206L below line 1208.

Referring still to FIG. 12, in the present embodiment, the exhaust openings, 1203, 1205, and 1207, of concentric annuli 1202, 1204 and 1206, respectively, are offset with respect to each other. That is, exhaust opening 1205 of annulus 1204 is located farther to the right, as shown in FIG. 12, than is the exhaust opening 1203 of annulus 1202. Similarly, exhaust opening 1207 of annulus 1206 is located farther to the right, as shown in FIG. 12, than is exhaust opening 1205 of annulus 1204.

In embodiments of the present invention, each of the concentric annuli 1202, 1204 and 1206, is configured such that, during operation, each of the concentric annuli, 1202, 1204 and 1206, has a distinct rotating detonation wave travelling between its respective outer and inner walls. Further, in embodiments of the present invention, during operation, the respective rotating detonation waves are generated such that at least two of the respective detonation waves exist concurrently for some period of time. In one embodiment, each of the respective detonation waves generated within concentric annuli 1202, 1204 and 1206 operates simultaneously and for the same duration of time. Additionally, in embodiments of the present invention, the distinct detonation wave of at least one of concentric annuli 1202, 1204 and 1206 is generated using, for example, a fuel mixture which differs from the fuel mixture used in another of concentric annuli 1202, 1204 and 1206. Embodiments of the present invention are also well suited to varying an oxidizer, a coolant, or other component utilized by one or more of concentric annuli 1202, 1204 and 1206.

Referring still to FIG. 12, the plurality of concentric annuli, as provided by embodiments of the present invention, utilize exhaust from at least two concentric annuli 1202, 1204 and 1206, in combination, to achieve a desired resultant or combined exhaust. For example, in embodiments of the present invention, one or more of concentric annuli 1202, 1204 and 1206 produces an exhaust which differs from the exhaust produced by another of concentric annuli 1202, 1204 and 1206. In various embodiments of the present invention, exhaust from one or more of concentric annuli 1202, 1204 and 1206 has at least one component that differs from the components present in the exhaust of one or more of concentric annuli 1202, 1204 and 1206. In another embodiment, exhaust from one or more of concentric annuli 1202, 1204 and 1206 has a ratio of components that differs from the ratio of components present in the exhaust produced by another of concentric annuli 1202, 1204 and 1206. Embodiments of the present invention are also well suited to generating exhaust from one or more of concentric annuli 1202, 1204 and 1206 wherein both at least one component and the ratio of components differs from the components and the ratio of components present in the exhaust from another of concentric annuli 1202, 1204 and 1206. As a result, embodiments of the present invention enable “tuning” of the exhaust produced by one or more of concentric annuli 1202, 1204 and 1206. Furthermore, embodiments of the present invention enable tuning of the resultant combined exhaust (i.e., the combination of the exhaust from at least two of concentric annuli 1202, 1204 and 1206). In various embodiments of the present invention, the resultant combined exhaust is specifically tuned to achieve a desired mixture for secondary combustion. For example, in some embodiments comprising three concentric annuli, the system can run 10% beyond stoichiometric (fuel rich) in the outer annulus, 5% richer than stoichiometric in the middle annulus, and stoichiometric in the inner annulus. An additional benefit of such embodiments is that the inner ring is hottest (because closest to stoichiometric) and also most separated from outer walls. Another key benefit of this multi-annular invention is throttling. RDREs are very challenging to throttle while maintaining stable detonation, and may be impossible to throttle below say 50%. Whereas in the present invention, one or more annuli may be switched off by interrupting fuel/and or oxidizer flow to select various combinations of thrust. For example, in some embodiments, the outer annulus may have a 6″ diameter, the middle annulus may have a 3″ diameter, and the inner annulus may have a 1″ diameter. In such an embodiment, switching off the two outer two rings reduces thrust to 10% of max. In additional embodiments, some portion of the fuel diverted for film cooling between each annulus (e.g., between the 1″ and 3″ annuli, and between the 3″ and 6″ annuli). In such embodiments, the combustion inside the annuli may be run fuel lean (less fuel to oxidizer than stoichiometric), such that there is excess oxidizer available for combustion as the film cooling fuel is ejected.

Referring again to FIG. 12, embodiments of the present invention, direct the flow of the exhaust from at least two of concentric annuli 1202, 1204 and 1206 to achieve a desired resultant or combined exhaust. In one embodiment, the exhaust from at least two of concentric annuli 1202, 1204 and 1206 are specifically directed such that the combined and/or resultant exhaust converges at a desired location. As an example, and as depicted in FIG. 12, the combustion exhaust from middle-positioned annulus 1204 is directed toward line 1208 by, at least partially, exhaust from outer-positioned annulus 1202. For example, with multiple annuli, the system may adjust mass flow rate so that combustion exhausts from each annulus converge naturally. Referring again to the above example embodiments of annuli with, diameters 6″, 3″, and 1″, where the exhaust from the 6″ expands 1½ inches, and the exhaust from the 3″ expands 1½ outward. In that and other three-annulus embodiments, the mass flow may be adjusted such that the mass flux per area is uniform on all three. Similarly, the combustion exhaust from inner-positioned annulus 1206 is directed toward line 1208 by, at least partially, exhaust from middle-positioned annulus 1204. In FIG. 12, the directed flow of exhaust from concentric annuli 1202, 1204 and 1206 is represented by arrows 1209, 1211 and 1213, respectively. It should be noted that embodiments of the present invention are well suited to utilizing various combinations of at least two of nested annuli to achieve the directed exhaust flow depicted in FIG. 12.

With reference again to FIG. 12, embodiments of the present invention produce a “virtual” nozzle cone. That is, in various embodiments, exhaust is directed or converged, as represented by arrows 1209, 1211 and 1213, toward a common region or location to obtain a desired resultant or combined exhaust. In so doing, the directed exhaust embodiments of the present invention create a converged exhaust similar to the convergence conventionally created using a physical nozzle cone. The virtual nozzle cone of the present embodiments is schematically depicted as 1221 of FIG. 12. Hence, embodiments of the present invention produce a “virtual” nozzle cone 1221. As a result, various embodiments of the present invention eliminate the need for a physical nozzle cone to converge exhaust. It should be noted that, in various embodiments, virtual nozzle 1221 also represents a location where the exhaust from at least two of concentric annuli 1202, 1204 and 1206 mixes to create the combined and/or resultant exhaust. Moreover, embodiments of the present invention also enable directing of exhaust from at least two of concentric annuli 1202, 1204 and 1206 in a direction and/or to a location other than the direction and/or location depicted in FIG. 12.

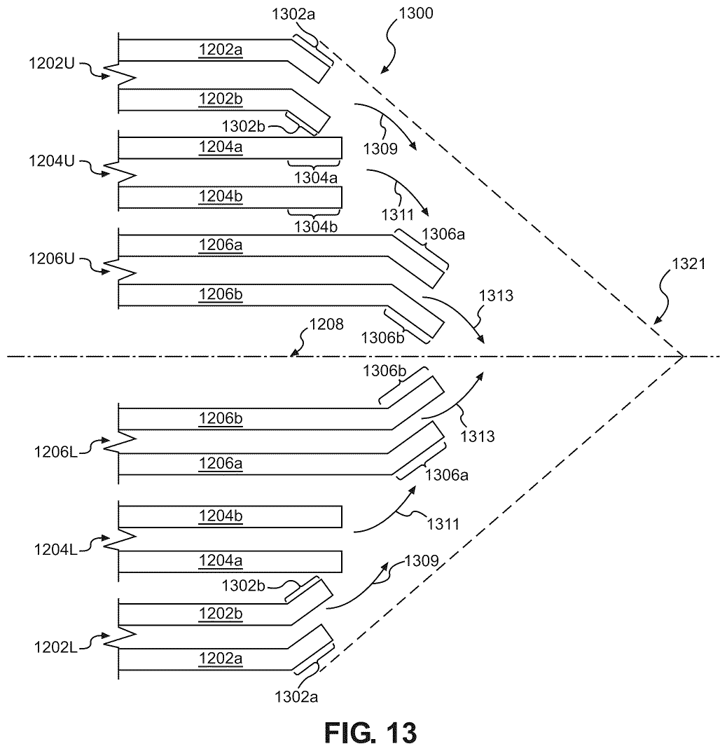

Referring now FIG. 13 a cross-sectional view of a series of nested annuli 1300 is provided wherein at least one of nested annuli 1202, 1204 and 1206 has an exhaust region which is not parallel with the exhaust region of at least one other of nested annuli 1202, 1204 and 1206. For example, and ss shown in FIG. 13, annulus 1202 has an exhaust region (i.e., a region proximate exhaust opening 1203 of FIG. 12) denoted by 1302a and 1302b. Also, annulus 1204 has an exhaust region (i.e., a region proximate exhaust opening 1205 of FIG. 12) denoted by 1304a and 1304b, and annulus 1206 has an exhaust region (i.e., a region proximate exhaust opening 1207 of FIG. 12) denoted by 1306a and 1306b. As can be seen in FIG. 13, and accordance with embodiments of the present invention, exhaust region 1304a and 1304b of annulus 1204 is not parallel with exhaust region 1302a and 1302b of annulus 1202. Likewise, exhaust region 1304a and 1304b of annulus 1204 is not parallel with exhaust region 1306a and 1306b of annulus 1206. Moreover, in various embodiments of the present invention, exhaust region 1302a and 1302b of annulus 1202 and exhaust region 1306a and 1306b of annulus 1206 are angled or bent (with respect to the remaining portions of annulus 1202 annulus 1206, respectively) to direct the flow of the exhaust from annulus 1202 and annulus 1206. As described above in conjunction with the discussion of the embodiments of FIG. 12, exhaust is directed or converged, as represented by arrows 1309, 1311 and 1313, toward a common region or location 1321 to obtain a desired resultant or combined exhaust. For purposes of brevity and clarity, the discussion of the directing of exhaust from annuli 1202 and 1206 and the embodiments corresponding to FIG. 13 will not repeat the entirety of the discussion corresponding to the embodiments of FIG. 12. It should be noted, however, that the various embodiment variations mentioned in the discussion corresponding to FIG. 12 also apply to the embodiments of FIG. 13.

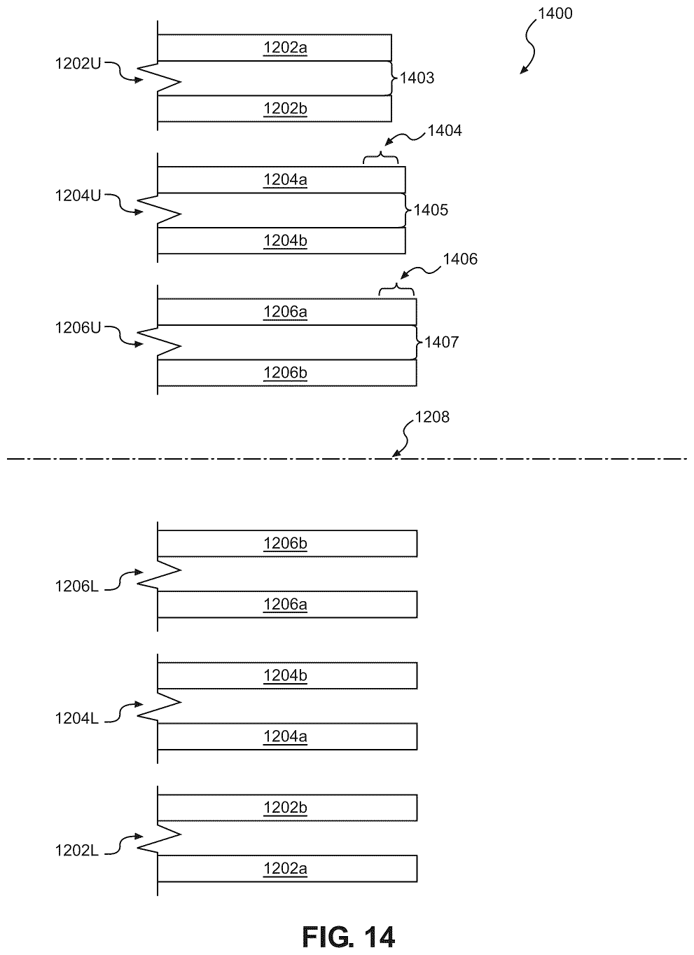

FIG. 14 is a cross-sectional view of a series of nested rotating detonation rocket engine (RDRE) annuli 1400 having parallel and non-offset exhaust openings, in accordance with embodiments of the present invention. For purposes of brevity and clarity, the discussion of annuli 1202, 1204 and 1206 and the embodiments corresponding to FIG. 14 will not repeat the entirety of the discussion corresponding to the embodiments of FIG. 12. In the embodiment of FIG. 14, the exhaust regions are denoted as 1402, 1404, and 1406, and the exhaust openings are denoted as 1403, 1405, and 1407. In the present embodiment, exhaust regions 1402, 1404, and 1406 and exhaust openings 1403, 1405, and 1407 of nested annuli 1202, 1204 and 1206, respectively, are aligned with each other. That is, unlike the embodiments of FIGS. 12 and 13, exhaust regions 1402, 1404, and 1406 of nested annuli 1202, 1204 and 1206, respectively, are parallel with each other. Also, exhaust openings 1403, 1405, and 1407 of nested annuli 1202, 1204 and 1206, respectively, are not offset with respect to each other. For purposes of brevity and clarity, the discussions of the embodiments corresponding to FIG. 14 will not repeat the entirety of the discussion corresponding to the embodiments of FIG. 12. It should be noted, however, that the various embodiment variations mentioned in the discussion corresponding to FIG. 12 also apply to the embodiments of FIG. 14.

Furthermore, embodiments of the present invention as described in conjunction with FIGS. 12-14 are well suited to use with various other features, cooling channels, port shapes, port types, and port configurations, as described above in detail in accordance with the embodiments of FIGS. 1-6, to, for example, provide coolant to the respective inner and/or outer walls of nested annuli 1202, 1204 and 1206. Additionally, in the embodiments of FIGS. 12-14, the respective inner and/or outer walls of nested annuli 1202, 1204 and 1206 are well suited to being treated in the same or similar manner as was described for wall 706b in the embodiments corresponding to FIGS. 7-11. Once again, for purposes of brevity and clarity, the discussion of the respective inner and/or outer walls of nested annuli 1202, 1204 and 1206, and the embodiments corresponding to FIGS. 12-14, will not repeat the entirety of the discussion corresponding to the embodiments of FIGS. 7-11. It should be noted, however, that the various embodiment variations mentioned in the discussion corresponding to FIGS. 7-11 also apply to the embodiments of FIGS. 12-14.

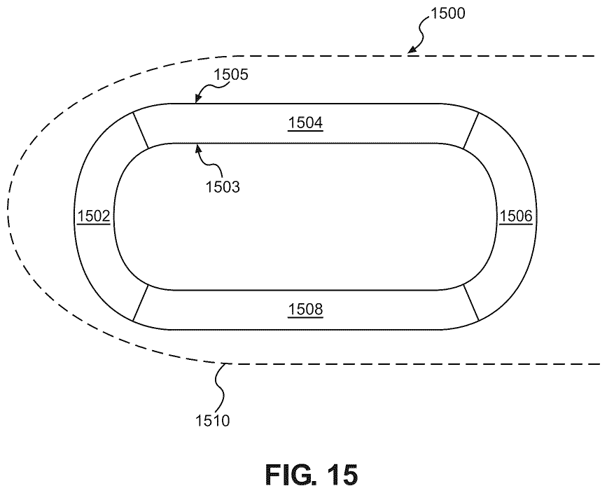

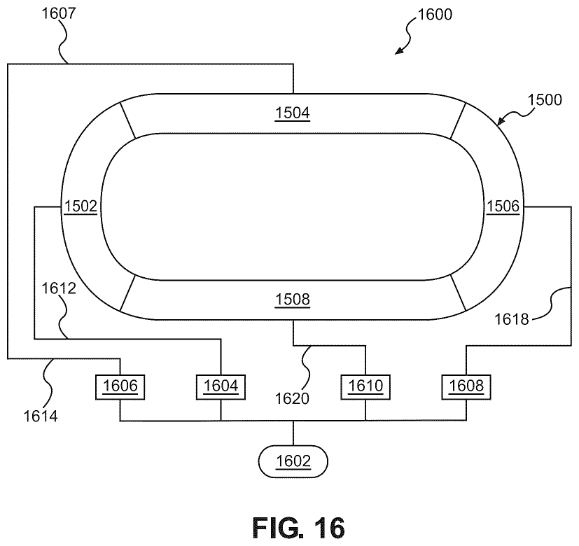

Referring next to FIG. 15, a cross-sectional view of a non-circular annulus (or detonation chamber) 1500 of a rotating detonation rocket engine (RDRE) is provided. As stated above, the term annulus is understood, and used by those in the RDRE art, to typically refer to an annular channel or, more generally, to a detonation chamber around which one or more detonations continuously travel. For the present discussion of the embodiments of FIG. 15 and FIG. 16, the term annulus is intended to refer to the RDRE detonation chamber, as used in the RDRE art, and is not intended to be limited to the geometric definition of “a region between concentric circles”. As shown in FIG. 15, an inner wall 1503 and an outer wall 1505 define a detonation chamber (also referred to as a detonation channel) therebetween. Moreover, in the present embodiment, and as will be discussed below in conjunction with the description of FIG. 16, non-circular annulus 1500 is shown to be comprised of several zones 1502, 1504, 1506 and 1508. It should be noted, however, that in various embodiments, non-circular annulus 1500 is not divided into zones. As stated previously, during operation of an RDRE, one or more detonation waves continuously travel around the detonation chamber. Although non-circular annulus 1500 is shown to have an oval shape in FIG. 15, embodiments of the present invention are well suited to various other non-circular shapes such as, but not limited to, elliptical, egg-shaped, and the like. Non-circular annulus 1500 of the present embodiments significantly increases packaging options for an RDRE engine. For example, non-circular annulus 1500 enables an RDRE to fit into a vehicle where the vehicle's shape constraints previously rendered the use of an RDRE infeasible or impossible. As one example, an RDRE utilizing non-circular annulus 1500 is particularly well suited to being packaged into a wing of an aircraft or spacecraft wherein the length of the wing is much greater than the height of the wing. Dotted line 1510 in FIG. 15 is provided to represent the outline of a portion of an aircraft wing and demonstrate the beneficial packaging characteristics of the present non-circular annulus 1500.

Referring now to FIG. 16, a cross-sectional and schematic diagram 1600 of non-circular annulus 1500 with fuel zone control is provided. As stated above, in the present embodiment, non-circular annulus 1500 is comprised of several zones 1502, 1504, 1506 and 1508. Although FIG. 16 depicts non-circular annulus 1500 as having four zones (1502, 1504, 1506 and 1508), the “fuel zone control” embodiments of the present invention are well suited to having two or more zones within non-circular annulus 1500. In embodiments of the present invention, fuel is selectively deliverable to zones 1502, 1504, 1506 and 1508 of non-circular annulus 1500. More specifically, in embodiments of the present invention, at least one of the zones of non-circular annulus 1500 has independent fuel control. For the present discussion, independent fuel control refers to the ability to selectively control fueling of at least one zone such that the fueling of the at least one zone can differ from the fueling of another zone. In embodiments of the present invention, fueling of the zone with independent fuel control can differ from the fueling of another zone in any of numerous ways. For example, the zone with independent fuel control can receive a greater or lesser amount of fuel than is received by another zone. The zone with independent fuel control can receive a fuel mixture which differs from the fuel mixture supplied to another zone. The independent fuel control embodiments of the present invention are well-suited to use with any of various possible approaches which allow the zone with independent fuel control to be fueled differently than another zone. Further, it should be noted that the present invention is not limited to embodiments in which each of the zones has independent fuel control as is depicted in FIG. 16. Instead, embodiments of the present invention are well suited to an implementation in which any one, or more than one, of the zones has independent fuel control. Oxidizer is delivered along with the fuel in a manner familiar to those skilled in the art. In other embodiments, oxidizer is selectively delivered instead of fuel.

Referring again to FIG. 16, in one embodiment, a fuel supply 1602 is fluidically coupled with each of fuel manifold 1604, fuel manifold 1606, fuel manifold 1608 and fuel manifold 1610. Additionally, in the embodiment of FIG. 16, fuel manifold 1604 is fluidically coupled with zone 1502 of non-circular annulus 1500 via supply line 1612. Fuel manifold 1606 is fluidically coupled with zone 1504 of non-circular annulus 1500 via supply line 1614. Fuel manifold 1608 is fluidically coupled with zone 1506 of non-circular annulus 1500 via supply line 1618. Fuel manifold 1610 is fluidically coupled with zone 1508 of non-circular annulus 1500 via supply line 1620. Thus, in the present embodiment, each of zones 1502, 1504, 1506 and 1508 of non-circular annulus 1500 has a separate fuel manifold 1604, 1606, 1608 and 1610, respectively. In embodiments of the present invention, the separate fuel manifolds 1604, 1606, 1608 and 1610 are then used to selectively vary the fuel provided to each of zones 1502, 1504, 1506 and 1508, respectively, of non-circular annulus 1500.

With reference still to FIG. 16, in embodiments of the present invention, by selectively varying the fuel supplied to each of zones 1502, 1504, 1506 and 1508 of non-circular annulus 1500, the thrust generated by each zone is varied. In so doing, embodiments of the present invention enable thrust vectoring (i.e., manipulating the direction of thrust) for non-circular annulus 1500. As an example, in one embodiment, fuel manifold 1604 is utilized to provide a greater amount of fuel than is provided to zone 1506 via fuel manifold 1608. In such an embodiment, zone 1502 will generate a greater amount of thrust than is generated by zone 1506. Assuming that the thrust direction from non-circular annulus 1500 is into the page (with respect to FIG. 16), this imbalance of thrust generated across non-circular annulus 1500, and the RDRE in which non-circular annulus 1500 is disposed, will cause the vehicle in which RDRE is located to yaw to the right. It should be noted that the any one or more of pitch, yaw and roll for a vehicle can be adjusted by selectively varying the fuel supplied to one or more of zones 1502, 1504, 1506 and 1508 of non-circular annulus 1500. It should also be noted that fuel supply 1602 of FIG. 16 is schematically represented for clarity. It will be understood that fuel supply 1602 can be comprised of, for example, separate and distinct supplies of oxidizer and fuel, separate and distinct supplies of differing fuels, and the like.

Furthermore, embodiments of the present invention as described in conjunction with FIGS. 15-16 are well suited to use with various other features, cooling channels, port shapes, port types, and port configurations, as described above in detail in accordance with the embodiments of FIGS. 1-6, to, for example, provide coolant to inner wall 1503 and/or outer wall 1505 of non-circular annulus 1500. Additionally, in the embodiments of FIGS. 15-16, inner wall 1503 and/or outer wall 1505 of non-circular annulus 1500 are well suited to being treated in the same or similar manner as was described for wall 706b in the embodiments corresponding to FIGS. 7-11. Once again, for purposes of brevity and clarity, the discussion of the inner wall 1503 and/or outer wall 1505 of non-circular annulus 1500 and the embodiments corresponding to FIGS. 15-16 will not repeat the entirety of the discussion corresponding to the embodiments of FIGS. 7-11. It should be noted, however, that the various embodiment variations mentioned in the discussion corresponding to FIGS. 7-11 also apply to the embodiments of FIGS. 15-16. Moreover, embodiments of the present invention, as described in conjunction with FIGS. 15-16, are well suited to having a plurality of nested non-circular annuli. As nested annuli embodiments are described above in detail, and for purposes of brevity and clarity, a discussion of an RDRE having a plurality of non-circular annuli, and the embodiments corresponding to FIGS. 15-16 will not repeat the entirety of the discussion corresponding to the embodiments of FIGS. 12-14. It should be noted, however, that the various embodiment variations mentioned in the discussion corresponding to FIGS. 12-14 also apply to the embodiments of FIGS. 15-16.

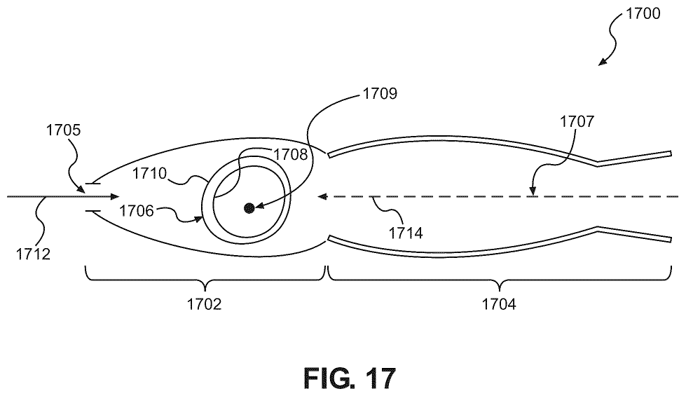

Referring now to FIG. 17, a cut-away top view of a combined cycle combustion system 1700 is provided. Combined cycle combustion system 1700 includes a rotating detonation rocket engine (RDRE) 1702 in combination with a second propulsion system 1704 wherein the thrust vector for RDRE 1702 is not parallel with the thrust vector for second propulsion system 1704. In one embodiment, second propulsion system 1704 is a ramjet. It should be noted, however, that embodiments of the present invention are well suited to utilizing various other propulsion systems for second propulsion system 1704. For example, in one embodiment, second propulsion system 1704 is a supersonic combustion ramjet (scramjet). Additionally, in embodiments of the present invention, the thrust vector of RDRE as produced by annulus 1706 is into of the page (with respect to FIG. 17), while the thrust vector of second propulsion system 1704 is in the direction depicted by arrow 1714. Hence, in embodiments of the present invention, the direction of the thrust vector for RDRE 1702 (into the page with respect to FIG. 17) is not parallel with the direction of the thrust vector (depicted by arrow 1714) for second propulsion system 1704.

With reference again to FIG. 17, RDRE 1702 includes an annulus 1706. Annulus 1706 is comprised of an inner wall 1708 and an outer wall 1710 which define a detonation chamber (also referred to as a detonation channel) therebetween. Additionally, in the embodiment of FIG. 17, inlet 1705 is provided to receive incoming induced air. The incoming induced air moves into combined cycle combustion system 1700 at inlet 1705 and proceeds along the direction shown by arrow 1712. A benefit is that cross-flow mixing will occur which will expand the ram air, resulting in thrust as it leaves. Added benefit, air scoops can present very small area (vs. for a typical turbojet or turboprop engine), resulting in much lower drag. In other embodiments, the air scoops are built into the airframe in such a way that they suck off the boundary layer before the wing starts to further reduce drag.

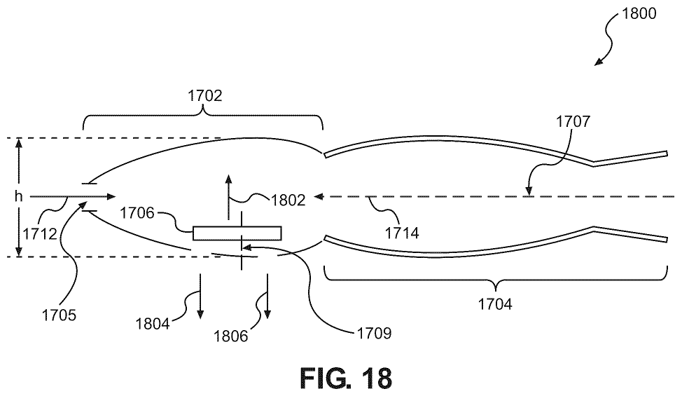

Referring now to FIG. 18, a cut-away side view of combined cycle combustion system 1700 of FIG. 17 is provided. As shown in FIG. 18, the direction of the thrust vector for RDRE 1702 is depicted by arrows 1804 and 1806. Furthermore, exhaust and heat from RDRE 1702 is expelled from annulus 1706 in the direction indicated by arrow 1802. Thus, in embodiments of the present invention, during operation of RDRE 1702, a detonation wave travelling around annulus 1706 will produce exhaust and heat which, in turn, affects incoming induced air travelling in the direction indicated by arrow 1712. More specifically, the exhaust and/or heat from RDRE 1702 increases the temperature of the induced air entering combined cycle combustion system 1700. Also, the exhaust and/or heat from RDRE 1702 increases the pressure within combined cycle combustion system 1700. As a result, embodiments of the present invention increase the temperature and the pressure of the incoming induced air prior to the incoming induced air reaching second propulsion system 1704. Also, the exhaust and/or heat from RDRE 1702 increases the pressure within combined cycle combustion system 1700, increases agitation of the air, promotes mixing within combined cycle combustion system 1700, and also improves any desired secondary combustion. For purposes of the present application, a secondary combustion, in one embodiment, occurs after the detonation process within, for example, RDRE 1702 but prior to any combustion and/or detonation occurring within second propulsion system 1704. In other embodiments, the secondary combustion occurs within second propulsion system 1704 during the combustion/detonation process of second propulsion system 1704. Further, in various embodiments, the present invention intentionally exhausts products such as, for example, fuel, oxidizer, coolant (e.g., coolant fuel) and the like, from RDRE 1702 such that these exhaust products increase agitation and mixing of the components of any secondary combustion. Thus, by increasing the temperature and the pressure of the incoming induced air prior to the incoming induced air reaching second propulsion system 1704, embodiments of the present invention increase the efficiency of second propulsion system 1704 without requiring additional fuel for second propulsion system 1704.

With reference still to FIG. 18, by orienting annulus 1706 of RDRE 1702 such that the thrust vector of RDRE 1702 is non-parallel with the thrust vector (depicted by arrow 1714) of second propulsion system 1704, embodiments of the present invention significantly increase packaging options for combined cycle combustion system 1700. For example, in an embodiment in which annulus 1706 is oriented with its central axis approximately orthogonal to the direction of incoming induced air (indicated by arrow 1712), the height, h, of RDRE 1702 can be reduced compared to an RDRE having an annulus oriented with its central axis approximately parallel to the direction of incoming induced air. As a result, embodiments of the present invention enable RDRE 1702, and combined cycle combustion system 1700 to be packaged into a vehicle where the vehicle's shape constraints previously rendered such use infeasible or impossible. As one example, combined cycle combustion system 1700 is particularly well suited to being packaged into a wing of an aircraft or spacecraft wherein, previously, the height of the wing would have prevented such packaging.

With reference again to FIG. 18, by orienting annulus 1706 of RDRE 1702 with the thrust vector in the direction depicted by arrows 1804 and 1806, embodiments of the present provide vertical take-off and landing (VTOL) capability for combined cycle combustion system 1700. For example, if combined cycle combustion system 1700 is rotated 180 degrees about its central axis from the position as depicted in FIG. 18 (i.e., with arrows 1804 and 1806 pointing upward), RDRE 1702 provides an upward thrust for combined cycle combustion system 1700. Moreover, embodiments of the present invention also enable thrust vectoring (i.e., manipulating the direction of thrust) of RDRE 1702, and, correspondingly, the resultant thrust vector for combined cycle combustion system 1700 by adjusting the extent to which the central axis of annulus 1706 varies from being parallel with, for example, the direction of incoming induced air (indicated by arrow 1712) and/or the central axis of combined cycle combustion system 1700. That is, in embodiments of the present invention, the orientation of RDRE 1702 and, more specifically, the orientation of a central axis (depicted as 1709 in FIG. 17 and FIG. 18) of annulus 1706 is adjustable with respect to, for example, a central axis of combined cycle combustion system 1700 (a portion of the central axis of combined cycle combustion system 1700 is depicted as 1707 in FIG. 17 and FIG. 18). As yet another advantage of the present embodiments, a typical rocket-based combined cycle (RBCC) including, for example, a conventional rocket combined with a ramjet, requires a “mixing distance” which is equal to at least ten times the length of the diameter of the RBCC to fully mix components of a desired secondary combustion. Embodiments of the present invention, however, utilize, for example, exhaust from RDRE 1702 to increase mixing of any secondary combustion components. Moreover, in embodiments of the present invention, by increasing the temperature and the pressure of the incoming induced air, by increasing agitation, and/or by intentionally allowing products such as, for example, fuel, oxidizer, coolant (e.g., coolant fuel) and the like, to exit RDRE 1702, embodiments of the present invention reduce the mixing distance to approximately twice the length of the diameter of combined cycle combustion system 1700. It will be understood that the mixing distance is defined as the minimal distance that combustible components must travel from the location where the combustible components are released to the location at which the combustible components have sufficiently mixed to be suitable for a secondary combustion.

It should be noted that the orientation of RDRE 1702 and annulus 1706 with respect to combined cycle combustion system 1700 can be described in numerous ways. For example, the orientation of RDRE 1702 and annulus 1706 can be described in terms of the thrust vector of RDRE 1702, the orientation of a central axis of annulus 1706, the direction of exhaust from RDRE 1702, and the like. Likewise, the orientation of combined cycle combustion system 1700 can be described in terms of the thrust vector of combined cycle combustion system 1700, the orientation of a central axis of combined cycle combustion system 1700, the direction of exhaust from combined cycle combustion system 1700, and the like.

Furthermore, embodiments of the present invention as described in conjunction with FIGS. 17-18 are well suited to use with various other features, cooling channels, port shapes, port types, and port configurations, as described above in detail in accordance with the embodiments of FIGS. 1-6, to, for example, provide coolant to inner wall 1708 and/or outer wall 1710 of annulus 1706. Additionally, in the embodiments of FIGS. 17-18, inner wall 1708 and/or outer wall 1710 of annulus 1706 are well suited to being treated in the same or similar manner as was described for wall 706b in the embodiments corresponding to FIGS. 7-11. Once again, for purposes of brevity and clarity, the discussion of the inner wall 1708 and/or outer wall 1710 of annulus 1706 and the embodiments corresponding to FIGS. 17-18 will not repeat the entirety of the discussion corresponding to the embodiments of FIGS. 7-11. It should be noted, however, that the various embodiment variations mentioned in the discussion corresponding to FIGS. 7-11 also apply to the embodiments of FIGS. 17-18. Moreover, embodiments of the present invention, as described in conjunction with FIGS. 17-18, are well suited to having a plurality of nested annuli. As nested annuli embodiments are described above in detail, and for purposes of brevity and clarity, a discussion of RDRE 1702 having a plurality of annuli, and the embodiments corresponding to FIGS. 17-18 will not repeat the entirety of the discussion corresponding to the embodiments of FIGS. 12-14. It should be noted, however, that the various embodiment variations mentioned in the discussion corresponding to FIGS. 12-14 also apply to the embodiments of FIGS. 17-18. Additionally, embodiments of the present invention, as described in conjunction with FIGS. 17-18, are well suited to embodiments wherein annulus 1706 is non-circular. As non-circular annulus embodiments are described above in detail, and for purposes of brevity and clarity, a discussion of RDRE 1702 having a non-circular annulus, and the embodiments corresponding to FIGS. 17-18 will not repeat the entirety of the discussion corresponding to the embodiments of FIGS. 15-16. It should be noted, however, that the various embodiment variations mentioned in the discussion corresponding to FIGS. 15-16 also apply to the embodiments of FIGS. 17-18.

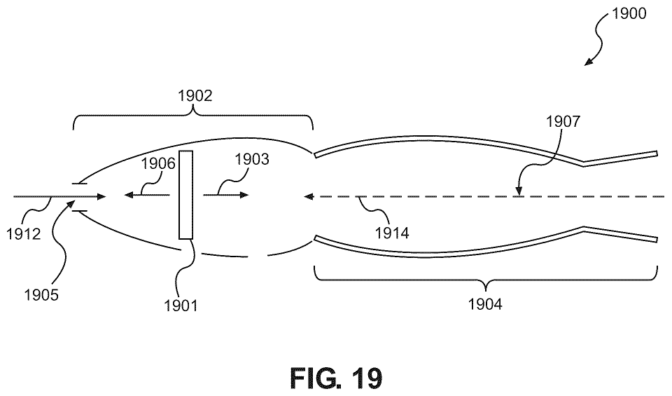

Referring now to FIG. 19, a cut-away side view of a combined cycle combustion system 1900 is provided. Combined cycle combustion system 1900 includes a rotating detonation rocket engine (RDRE) 1902 in combination with a second propulsion system 1904 wherein the thrust vector for RDRE 1902 (depicted by arrow 1906) is parallel with the thrust vector (depicted by arrow 1914) for second propulsion system 1904. In one embodiment, second propulsion system 1904 is a ramjet. It should be noted, however, that embodiments of the present invention are well suited to utilizing various other propulsion systems for second propulsion system 1904. For example, in one embodiment, second propulsion system 1904 is a supersonic combustion ramjet (scramjet). Additionally, in embodiments of the present invention, RDRE 1902 includes an annulus 1901. In embodiments of the present invention, the direction of the thrust vector for RDRE 1902 is parallel with the direction of the thrust vector (depicted by arrow 1914) for second propulsion system 1904.

With reference again to FIG. 19, in various embodiments, inlet 1905 is provided to receive incoming induced air. The incoming induced air moves into combined cycle combustion system 1900 at inlet 1905 and proceeds along the direction shown by arrow 1912. Furthermore, exhaust and heat from RDRE 1902 is expelled from annulus 1901 in the direction indicated by arrow 1903. Thus, in embodiments of the present invention, during operation of RDRE 1902, a detonation wave travelling around annulus 1901 will produce exhaust and heat which, in turn, affects incoming induced air travelling in the direction indicated by arrow 1912. More specifically, the exhaust and/or heat from RDRE 1902 increases the temperature of the induced air entering combined cycle combustion system 1900. Also, the exhaust and/or heat from RDRE 1902 increases the pressure within combined cycle combustion system 1900, increases agitation of the air, promotes mixing within combined cycle combustion system 1900, and also improves any desired secondary combustion. As a result, embodiments of the present invention increase the temperature and the pressure of the incoming induced air prior to the incoming induced air reaching second propulsion system 1904. Thus, by increasing the temperature and the pressure of the incoming induced air prior to the incoming induced air reaching second propulsion system 1904, embodiments of the present invention increase the efficiency (e.g., the Iₛₚ value) of second propulsion system 1904 without requiring additional fuel for second propulsion system 1904. Additionally, in various embodiments, the present invention intentionally allows products such as, for example, fuel, oxidizer, coolant (e.g., coolant fuel) and the like, to exit the RDRE 1902 such that these products increase agitation and mixing of the components of any secondary combustion. As mentioned above, for purposes of the present application, a secondary combustion, in one embodiment, occurs after the detonation process within, for example, RDRE 1902 but prior to any combustion and/or detonation occurring within second propulsion system 1904. In other embodiments, the secondary combustion occurs within second propulsion system 1904 during the combustion/detonation process of second propulsion system 1904.

With reference still to FIG. 19, as stated above, a rocket-based combined cycle (RBCC) including, for example, a conventional rocket combined with a ramjet, requires a “mixing distance” which is equal to at least ten times the length of the diameter of the RBCC to fully mix components of a desired secondary combustion. Embodiments of the present invention, however, utilize, for example, exhaust from RDRE 1902 to increase mixing of any secondary combustion components. Moreover, in embodiments of the present invention, by increasing the temperature and the pressure of the incoming induced air, by increasing agitation, and/or by intentionally allowing products such as, for example, fuel, oxidizer, coolant (e.g., coolant fuel) and the like, to exit RDRE 1902, embodiments of the present invention reduce the mixing distance to approximately twice the length of the diameter of combined cycle combustion system 1900.

It should be noted that the orientation of RDRE 1902 and annulus 1901 with respect to combined cycle combustion system 1900 can be described in numerous ways. For example, the orientation of RDRE 1902 and annulus 1901 can be described in terms of the thrust vector of RDRE 1902, the orientation of a central axis of annulus 1901, the direction of exhaust from RDRE 1902, and the like. Likewise, the orientation of combined cycle combustion system 1900 can be described in terms of the thrust vector of combined cycle combustion system 1900, the orientation of a central axis of combined cycle combustion system 1900, the direction of exhaust from combined cycle combustion system 1900, and the like.

Furthermore, embodiments of the present invention as described in conjunction with FIG. 19 are well suited to use with various other features, cooling channels, port shapes, port types, and port configurations, as described above in detail in accordance with the embodiments of FIGS. 1-6, to, for example, provide coolant to the walls of annulus 1901. Additionally, in the embodiments of FIG. 19, inner and outer walls (as described in detail above in conjunction with the description of FIGS. 12-16) of annulus 1901 are well suited to being treated in the same or similar manner as was described for wall 706b in the embodiments corresponding to FIGS. 7-11. Once again, for purposes of brevity and clarity, the discussion of the inner and/or outer walls of annulus 1901 and the embodiments corresponding to FIG. 19 will not repeat the entirety of the discussion corresponding to the embodiments of FIGS. 7-11. It should be noted, however, that the various embodiment variations mentioned in the discussion corresponding to FIGS. 7-11 also apply to the embodiments of FIG. 19. Moreover, embodiments of the present invention, as described in conjunction with FIG. 19, are well suited to having a plurality of nested annuli. As nested annuli embodiments are described above in detail, and for purposes of brevity and clarity, a discussion of RDRE 1902 having a plurality of annuli, and the embodiments corresponding to FIG. 19 will not repeat the entirety of the discussion corresponding to the embodiments of FIGS. 12-14. It should be noted, however, that the various embodiment variations mentioned in the discussion corresponding to FIGS. 12-14 also apply to the embodiments of FIG. 19.

Additionally, embodiments of the present invention, as described in conjunction with FIG. 19, are well suited to embodiments wherein annulus 1901 is non-circular. As non-circular annulus embodiments are described above in detail, and for purposes of brevity and clarity, a discussion of RDRE 1902 having a non-circular annulus, and the embodiments corresponding to FIG. 19 will not repeat the entirety of the discussion corresponding to the embodiments of FIGS. 15-16. It should be noted, however, that the various embodiment variations mentioned in the discussion corresponding to FIGS. 15-16 also apply to the embodiments of FIG. 19.

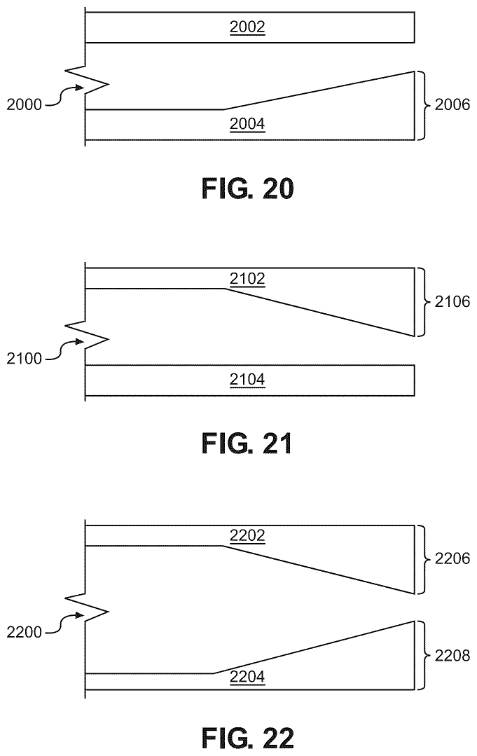

With reference now to FIGS. 20-22, in embodiments of the present invention, another goal is to provide increased mixing of the fuel for secondary combustion. One embodiment tapers the edge of the annulus to provide greater mixing. Additionally, the various embodiments depicted in FIGS. 20-22 promote detonation in a rotating detonation rocket engine (RDRE) by increasing back pressure due to the flow restriction generated by the geometry of tapered annulus edges.

Referring now to FIG. 19, a cut-away side view of a combined cycle combustion system 1900 having a rotating detonation rocket engine (RDRE) in combination with a second propulsion system 1907 and wherein the thrust vector for the RDRE is parallel with the thrust vector for the second propulsion system, in accordance with embodiments of the present invention. In another embodiment, an RBCC is comprised of an RDRE coupled with a RAM jet wherein the thrust vector of the RDRE is parallel with the thrust vector of the RAM jet. The exhaust from the RDRE is mixed with the intake air of a ramjet. Although a ramjet is mentioned here for purposes of brevity and clarity, it should be noted embodiments of the present invention are also well suited to use with, for example, a supersonic combustion ramjet (scramjet). A combined cycle is obtained as heat from the detonation wave of the RDRE and the corresponding exhaust from the RDRE increases the temperature and expands the induced air entering the RAM jet. This results in increased thrust for the RAM jet without requiring additional fuel for the RAM jet. A typical RBCC (rocket and ram) requires 10 diameters to fully mix. Present invention is able to mix more quickly due to agitation caused by rotating detonation exhaust, increase in temperature and pressure of incoming induced air. ISP is increased compared with conventional RBCCs.

Furthermore, embodiments of the present invention as described in conjunction with FIG. 19 are well suited to use with various other features, cooling channels, port shapes, port types, and port configurations, as described above in detail in accordance with the embodiments of FIGS. 1-6, to, for example, provide coolant to the inner and/or outer walls of annulus 1901. Additionally, in the embodiments of FIG. 19, the inner and/or outer walls of annulus 1901 are well suited to being treated in the same or similar manner as was described for wall 706b in the embodiments corresponding to FIGS. 7-11. Once again, for purposes of brevity and clarity, the discussion of the inner and/or outer walls of annulus 1901 and the embodiments corresponding to FIG. 19 will not repeat the entirety of the discussion corresponding to the embodiments of FIGS. 7-11. It should be noted, however, that the various embodiment variations mentioned in the discussion corresponding to FIGS. 7-11 also apply to the embodiments of FIG. 19. Moreover, embodiments of the present invention, as described in conjunction with FIG. 19, are well suited to having a plurality of nested annuli in RDRE 1902. As nested annuli embodiments are described above in detail, and for purposes of brevity and clarity, a discussion of RDRE 1902 having a plurality of annuli, and the embodiments corresponding to FIG. 19 will not repeat the entirety of the discussion corresponding to the embodiments of FIGS. 12-14. It should be noted, however, that the various embodiment variations mentioned in the discussion corresponding to FIGS. 12-14 also apply to the embodiments of FIG. 19. Additionally, embodiments of the present invention, as described in conjunction with FIG. 19, are well suited to embodiments wherein annulus 1901 is non-circular. As non-circular annulus embodiments are described above in detail, and for purposes of brevity and clarity, a discussion of RDRE 1901 having a non-circular annulus, and the embodiments corresponding to FIG. 19 will not repeat the entirety of the discussion corresponding to the embodiments of FIGS. 15-16. It should be noted, however, that the various embodiment variations mentioned in the discussion corresponding to FIGS. 15-16 also apply to the embodiments of FIG. 19.

With reference next to FIGS. 20-22, cut-away side views of walls defining an annulus of an RDRE are provided. FIGS. 20-22 also depict an agitating feature. Moreover, and as stated above, the various embodiments depicted in FIGS. 20-22 advantageously promote detonation in a rotating detonation rocket engine (RDRE) by increasing back pressure due to the flow restriction generated by the geometry of tapered annulus edges. Additionally, embodiments of the present invention are well-suited to varying the geometry of the tapered annulus edges to adjust detonation characteristics including, but not limited to, detonation wave stability and/or detonation wave strength. In FIG. 20, a portion of an annulus 2000 is depicted. Annulus 2000 of FIG. 20 includes an outer wall 2002 and an inner wall 2004 which define an annular chamber therebetween. As shown in FIG. 20, inner wall 2004 has a tapered profile. In FIG. 21, a portion of an annulus 2100 is depicted. Annulus 2100 of FIG. 21 includes an outer wall 2102 and an inner wall 2104 which define an annular chamber therebetween. As shown in FIG. 21, outer wall 2102 has a tapered profile. In FIG. 22, a portion of an annulus 2200 is depicted. Annulus 2200 of FIG. 22 includes an outer wall 2202 and an inner wall 2204 which define an annular chamber therebetween. As shown in FIG. 22, both outer wall 2202 and inner wall 2204 have a tapered profile. In embodiments of the present invention, the tapered profile formed on one or both of an inner wall and an outer wall increases mixing of components (i.e., agitates) exiting annuli 2000, 2100 and 2200.

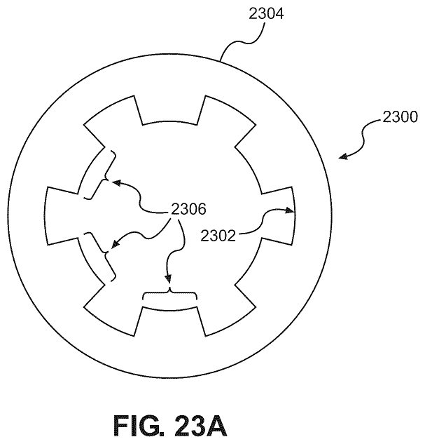

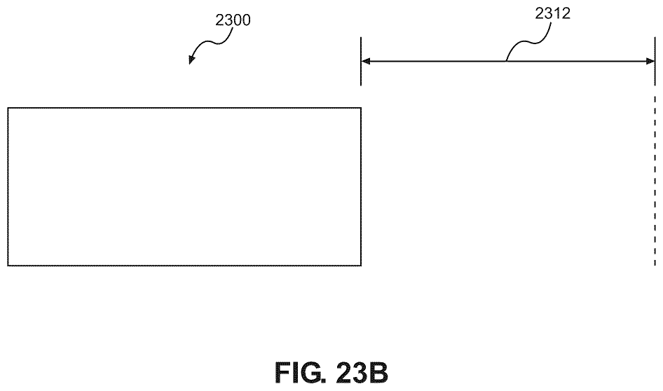

Referring now to FIG. 23A, an annulus 2300 including an inner wall 2302 and an outer wall 2304 is shown in a front view. In annulus 2300, inner wall 2302 has crenellations (typically shown as 2306) extending therefrom such that a crenellated profile is generated on the inner surface of annulus 2300. As stated above, embodiments of the present RDRE invention provide increased mixing of the fuel used in a secondary combustion. In embodiments of the present invention, the crenellated profile formed on inner wall 2302 (and/or outer wall 2304 in various embodiments) increases mixing of (i.e., agitates) components exiting annulus 2300. FIG. 23B is a side view of annulus 2300, and depicts a mixing length 2312. As a result, various embodiments of the present reduce the mixing distance 2312 to a length which is many times shorter than the mixing length of conventional systems. Moreover, in various embodiments of the present invention, the mixing length is reduced to approximately twice the length of the diameter of combined cycle combustion system 1700. In other embodiments, the crenelations may be placed on the outer wall of the annulus. In another embodiment, the initial injectors operate oxidizer rich to reduce temperatures, and fuel is added later (up to an appropriate stoichiometry) to increase combustion and/or detonation performance.

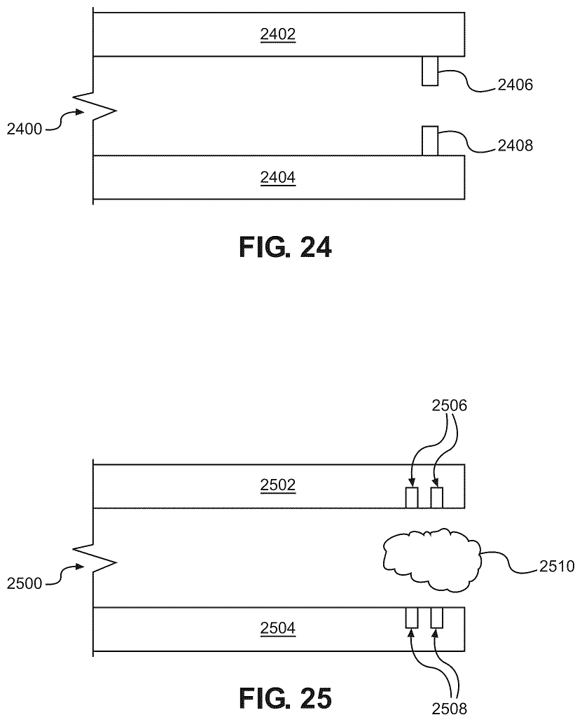

Referring now to FIG. 24, a cut-away side view of walls defining an annulus 2400 of an RDRE is provided. In FIG. 24, a portion of an annulus 2400 is depicted. Annulus 2400 of FIG. 24 includes an outer wall 2402 and an inner wall 2404 which define an annular chamber therebetween. As shown in FIG. 24, outer wall 2402 has a ceramic cylinder 2406 extending therefrom and into the annular chamber. Similarly, inner wall 2404 has a ceramic cylinder 2408 extending therefrom and into the annular chamber. Embodiments of the present invention are well suited to having one or more of the ceramic cylinders disposed on one or both of outer wall 2402 and inner wall 2404. In one embodiment, ceramic cylinders enable increased mixing of (i.e. agitating the flow) components existing the annulus 2400. In other embodiments of the present RDRE invention provide increased mixing of the fuel used in a secondary combustion. In embodiments of the present invention, the ceramic cylinders disposed on inner wall 2404 and outer wall 2402 increase mixing of (i.e., agitates) components exiting annulus 2400. In various embodiments of the present invention, fuel and/or oxidizer is injected through ceramic cylinders 2408 into annulus 2400. In such an embodiment, by ensuring oxygen rich combustion in the annular chamber, exhaust products exiting annulus 2400 have free oxygen available for secondary combustion further downstream. Additionally, embodiments of the present invention enable improved thermal management of the annular chamber walls (e.g., inner wall 2404 and outer wall 2402) which are exposed to combustion products inside annulus 2400.

Referring now to FIG. 25, a cut-away side view of walls defining an annulus 2500 of an RDRE is provided. In FIG. 25, a portion of an annulus 2500 is depicted. Annulus 2500 of FIG. 25 includes an outer wall 2502 and an inner wall 2504 which define an annular chamber therebetween. As shown in FIG. 25, outer wall 2502 has piercings (typically shown as 2506) therein. Similarly, inner wall 2504 has piercings (typically shown as 2508) therein. Embodiments of the present invention are well suited to having one or more of the piercings formed into one or both of outer wall 2502 and inner wall 2504. As stated above, embodiments of the present RDRE invention provide increased mixing of the fuel used in a secondary combustion. In embodiments of the present invention, the piercings formed into inner wall 2504 and outer wall 2502 increase mixing of (i.e., agitates) components exiting annulus 2500. Additionally, in one embodiment, piercings (typically shown as 2506 and 2508) allow the introduction of fuel which creates a new secondary combustion zone 2510, which also promotes additional mixing.

Furthermore, embodiments of the present invention as described in conjunction with FIGS. 20-25 are well suited to use with various other features, cooling channels, port shapes, port types, and port configurations, as described above in detail in accordance with the embodiments of FIGS. 1-6, to, for example, provide coolant to an inner wall and/or an outer wall of any of annuli 2000, 2100, 2200, 2300, 2400 and 2500. Additionally, in the embodiments of FIGS. 20-25, the respective inner walls and/or the respective outer walls of any of annuli 2000, 2100, 2200, 2300, 2400 and 2500 are well suited to being treated in the same or similar manner as was described for wall 706b in the embodiments corresponding to FIGS. 7-11. Once again, for purposes of brevity and clarity, the discussion of the respective inner walls and/or the respective outer walls of any of annuli 2000, 2100, 2200, 2300, 2400 and 2500, and the embodiments corresponding to FIGS. 20-25 will not repeat the entirety of the discussion corresponding to the embodiments of FIGS. 7-11. It should be noted, however, that the various embodiment variations mentioned in the discussion corresponding to FIGS. 7-11 also apply to the embodiments of FIGS. 20-25. Moreover, embodiments of the present invention, as described in conjunction with FIGS. 20-25, are well suited to use in conjunction with a plurality of nested annuli as shown, for example, in FIG. 12. As nested annuli embodiments are described above in detail, and for purposes of brevity and clarity, a discussion of the respective inner walls and/or the respective outer walls of any of annuli 2000, 2100, 2200, 2300, 2400 and 2500, and the embodiments corresponding to FIGS. 20-25 will not repeat the entirety of the discussion corresponding to the embodiments of FIGS. 12-14. It should be noted, however, that the various embodiment variations mentioned in the discussion corresponding to FIGS. 12-14 also apply to the embodiments of FIGS. 20-25. Additionally, embodiments of the present invention, as described in conjunction with FIGS. 20-25, are well suited to embodiments wherein the thrust vector for an annulus is not parallel with the thrust vector of the second propulsion system. As such “not parallel” thrust vector embodiments are described above in detail, and for purposes of brevity and clarity, a discussion of an RDRE having a thrust vector which is not parallel with the thrust vector of the second propulsion system is not repeated here. Moreover, the embodiments corresponding to FIGS. 20-25 will not repeat the entirety of the discussion corresponding to the embodiments of FIGS. 17-18. It should be noted, however, that the various embodiment variations mentioned in the discussion corresponding to FIGS. 17-18 also apply to the embodiments of FIGS. 20-25. Also, embodiments of the present invention, as described in conjunction with FIGS. 20-25, are well suited to embodiments wherein an annulus has a thrust vector which is not parallel to the thrust vector of the second propulsion system. As such “not parallel” thrust vector embodiments are described above in detail, and for purposes of brevity and clarity, a discussion of an RDRE having a non-circular annulus, and the embodiments corresponding to FIGS. 20-25 will not repeat the entirety of the discussion corresponding to the embodiments of FIGS. 17-18. It should be noted, however, that the various embodiment variations mentioned in the discussion corresponding to FIGS. 17-18 also apply to the embodiments of FIGS. 20-25.

The foregoing Description of Embodiments is not intended to be exhaustive or to limit the embodiments to the precise form described. Instead, example embodiments in this Description of Embodiments have been presented in order to enable persons of skill in the art to make and use embodiments of the described subject matter. Moreover, various embodiments have been described in various combinations. However, any two or more embodiments may be combined. Although some embodiments have been described in a language specific to structural features and/or methodological acts, it is to be understood that the subject matter defined in the appended Claims is not necessarily limited to the specific features or acts described above. Rather, the specific features and acts described above are disclosed by way of illustration and as example forms of implementing the Claims and their equivalents.

What is claimed is:

1. A rotating detonation engine system comprising:
a fuel source containing a fuel, said fuel source configured for providing said fuel to a combustion chamber of a rotating detonation engine;
a liquid peroxide source, said liquid peroxide source configured for providing said liquid peroxide within said rotating detonation engine such that a first surface of a wall partially defining said combustion chamber of said rotating detonation engine is cooled; and
a monitor configured to control a flow of said fuel and a flow of said liquid peroxide, said monitor further configured to ensure that a stoichiometry of a combination of said fuel and said liquid peroxide is appropriate for generating a combustion of said combination of said fuel and said liquid peroxide.

2. The rocket engine system of claim 1 wherein said first surface of said wall is cooled by application of said liquid peroxide to said first surface of said wall.

3. The rocket engine system of claim 1 wherein said first surface of said wall is cooled by application of products of a decomposition of said liquid peroxide to said first surface of said wall.

4. A rotating detonation engine combustion system comprising:
a first annulus structure comprising:
a first inner wall;
a first outer wall, wherein said first inner wall and said first outer wall define an annular chamber therebetween; and
a first exhaust region having a first exhaust opening through which a first exhaust from said rotating detonation engine combustion system exits said first annular chamber; and
a second annulus structure comprising:
a second inner wall;
a second outer wall, wherein said second inner wall and said second outer wall define a second annular chamber therebetween; and
a second exhaust region having a second exhaust opening through which a second exhaust from said rotating detonation engine combustion system exits said second annular chamber, wherein at least a portion of said second annulus structure is surrounded by at least a portion of said first annulus structure such that said second annulus structure is nested within said first annulus structure, and wherein said first exhaust region is disposed proximate said second exhaust region such that, during operation of said rotating detonation engine combustion system, said first exhaust and said second exhaust combine to generate a combined exhaust.

5. The rotating detonation engine combustion system of claim 4, wherein said first exhaust and said second exhaust are directed to a desired location to form said combined exhaust.

6. The rotating detonation engine combustion system of claim 4, wherein said first exhaust and said second exhaust are directed to form a virtual nozzle cone.

7. The rotating detonation engine combustion system of claim 6, wherein said virtual nozzle cone eliminates the need for a physical nozzle cone in said rotating detonation engine combustion system.

8. The rotating detonation engine combustion system of claim 4, wherein said first annulus structure and said second annulus structure are concentric.

9. The rotating detonation engine combustion system of claim 4, wherein at least a portion of said first exhaust region is not parallel with at least a portion of said second exhaust region.

10. A rotating detonation engine combustion system comprising:
a non-circular annulus, said non-circular annulus further comprising;
an inner wall; and
an outer wall, wherein said inner wall and said outer wall define a non-circular detonation chamber therebetween.

11. A rotating detonation engine combustion system comprising:
a non-circular annulus, said non-circular annulus further comprising;
an inner wall; and
an outer wall, wherein said inner wall and said outer wall define a non-circular detonation chamber therebetween; and
a plurality of zones disposed between said inner wall and said outer wall, said plurality of zones comprising at least a portion of said non-circular detonation chamber of said rotating detonation engine combustion system.

12. The rotating detonation engine combustion system of claim 11, wherein fueling of a first zone of said plurality of zones is selectively controllable such that said fueling of said first zone of said plurality of zones can differ from fueling of a second zone of said plurality of zones.

13. The rotating detonation engine combustion system of claim 12 wherein said selectively controllable fueling of said first zone of said plurality of zones is able to contribute to thrust vectoring for said non-circular annulus.

14. A combined cycle combustion system comprising:
an air inlet, said air inlet configured to permit air to enter said combined cycle combustion system;
a first propulsion system comprising;
a rotating detonation rocket engine (RDRE), said RDRE including an
annulus having a central axis, said central axis of said annulus not parallel with a central axis of said combined cycle combustion system; and
a second propulsion system coupled with said RDRE, said RDRE disposed between said air inlet and said second propulsion system, said RDRE oriented such that, during operation of said combined cycle combustion system, exhaust from said RDRE will affect said air prior to said air being received by said second propulsion system.

15. The combined cycle combustion system of claim 14 wherein said RDRE increases a temperature and a pressure of said air prior to said air being received by said second propulsion system.

16. The combined cycle combustion system of claim 14 wherein said RDRE is disposed such that a thrust vector of said RDRE is not parallel with a thrust vector of said second propulsion system.

17. The combined cycle combustion system of claim 14 wherein said RDRE is disposed such that a thrust vector of said RDRE is not parallel with a resultant thrust vector of said combined cycle combustion system.

18. The combined cycle combustion system of claim 14 wherein an orientation of said RDRE with respect to said central axis of said combined cycle combustion system is adjustable.

19. The combined cycle combustion system of claim 14 wherein said combined cycle combustion system is configured to enable thrust vectoring for said combined cycle combustion system by adjusting an orientation of said RDRE with respect to said central axis of said combined cycle combustion system.

20. The combined cycle combustion system of claim 14 wherein said RDRE is configured to provide vertical take-off and landing (VTOL) capability for said combined cycle combustion system.

21. A combined cycle combustion system comprising:
an air inlet, said air inlet configured to permit air to enter said combined cycle combustion system;
a first propulsion system comprising;
a rotating detonation rocket engine (RDRE), said RDRE including an
annulus having a central axis, said central axis of said annulus parallel with a central axis of said combined cycle combustion system; and
a second propulsion system coupled with said RDRE, said RDRE disposed between said air inlet and said second propulsion system, said RDRE oriented such that, during operation of said combined cycle combustion system, exhaust from said RDRE will affect said air prior to said air being received by said second propulsion system.

22. The combined cycle combustion system of claim 21 wherein said RDRE increases a temperature and a pressure of said air prior to said air being received by said second propulsion system.

23. A rotating detonation engine annulus comprising:
an inner wall; and
an outer wall, wherein said inner wall and said outer wall define a detonation chamber therebetween; and
an agitating feature present near an exhaust opening of at least one of said inner wall and said outer wall.

24. The rotating detonation engine annulus of claim 23, wherein said agitating feature is selected from the group consisting of: a tapered profile, a crenellation, a ceramic cylinder and a piercing.
